(19) United States
(12) Patent Application Publication
(10) Pub. No.: US 2025/0001363 A1
(43) Pub. Date: Jan. 2, 2025

(54) SYSTEMS AND METHODS FOR SIZE SELECTIVE ELECTRODIALYTIC DESALTING

(71) Applicant: Board of Regents, The University of Texas System, Austin, TX (US)

(72) Inventor: Charles Phillip SHELOR, Arlington, TX (US)

(21) Appl. No.: 18/708,879

(22) PCT Filed: Dec. 14, 2022
(86) PCT No.: PCT/US2022/052853

§ 371 Date: May 9, 2024

Related U.S. Application Data
(60) Provisional application No. 63/289,336, filed on Dec. 14, 2021.

(51) Int. Cl. B01D 61/46; B01D 61/14; B01D 61/52; B01D 61/58; C02F 1/44; C02F 1/46

(52) U.S. Cl. CPC B01D 61/46; B01D 61/145; B01D 61/52; B01D 61/58; C02F 1/444; C02F 1/4604; B01D 2311/2603; B01D 2317/08; B01D 2325/42; C02F 2301/08

(57) ABSTRACT

The present disclosure is generally directed to membrane based electrodialytic desalinators, systems incorporating electrodialytic desalinators, and methods for the selective removal of mobile phase buffer/salt constituents in liquid chromatography that can be used to retain larger charged molecules such as proteins prior to mass spectrometric detection. According to some aspects, systems can include dialysis membranes (DMs) paired with ion exchange membranes (IEMs). The DMs can be in contact with an effluent channel and prevent loss of large charged molecules to the IEMs. Ions can be removed under an applied electric field using electrodes along the flow channel.

### RELATED APPLICATION DATA AND PRIORITY CLAIM

This application claims the priority benefit pursuant to Article 8 of the Patent Cooperation Treaty to U.S. Provisional Patent Application No. 63/289,336 filed on Dec. 14, 2021, the contents of which are incorporated by reference in their entirety.

### FIELD

The present disclosure is directed to desalting devices, systems, and methods. In particular, implementations of the present disclosure may be coupled with liquid chromatography (LC) mass spectrometry (MS) systems to enhance resolution and sensitivity of certain ionizable molecules (e.g., proteins, oligonucleotides, etc.).

### BACKGROUND

Salts, particularly non-volatile salts, can be detrimental to analysis using electrospray ionization mass spectrometry (ESI-MS). These salts can lead to signal suppression and complication of the mass spectrum by the formation of adducts. The degree to which each effect occurs in many cases can be salt dependent. While signal suppression is less affected using volatile salts such as ammonium acetate (AmOAc), recommended concentrations are still generally≤25 mM, though instrumentation has become more tolerant to higher concentrations, with successful analysis demonstrated for up to 250 mM AmOAc or even 1 M ammonium bicarbonate.

ESI-MS is often coupled to liquid chromatography (LC), but separation techniques are generally limited to those compatible with ESI-MS, most commonly reverse-phase LC (RPLC). Separations which use higher ionic strengths such as ion exchange chromatography (IC) or hydrophobic interaction chromatography are less frequently coupled directly to ESI-MS using volatile salts. In some cases, use of RPLC with MS often requires compromise between separation and detection using ion pairing agents leading to MS signal suppression.

Some strategies have emerged for improving instrument tolerance to mobile phase salts or for removal of salts prior to ESI-MS. Addition of amino acids to the mobile phase or organic vapors to the spray helps reduce adduct formation by forming ion clusters, but these techniques are typically more effective at low mM concentrations. Reducing the flow rate or using nano-ESI results in smaller droplets and an increase in excess charge in the electrospray, reducing competition of the analyte with the salt. Nano-ESI in particular has proven useful for native protein analysis even in phosphate buffered saline with <100 nm diameter emitter tips. While salt adduct formation remains an issue, it may be partially alleviated by electrokinetic separation/trapping of the higher mobility salts at the emitter using either step-voltage programming or polarity reversing of the spray voltage or elctrophoretic desalting. In some cases, mobile ions are eluted respectively before or after the proteins reducing adduct formation. Addition of a second high-voltage electrode into the ESI capillary separated from the solution by an air-gap has been used to sequester ions away from the spray tip and detected proteins even in the presence of 150 mM KCl. These techniques, however, require intermittent release of the accumulated ions and are unlikely to be coupled with LC. Further, nano-ESI emitters are fragile, easily clogged, and can be difficult to replicate.

Alternatively, removal of salt prior to the MS may be used. Desalting of the collected fractions via RPLC prior to MS can be performed. Comprehensive 2D-LC is possible using RPLC in the second dimensions, but relative to 1D or direct analysis this is both more time consuming and complex. Online microdialysis units have been developed whereby the smaller effluent ions may diffuse through a semipermeable membrane capillary with strict pore sizes to retain the larger molecules of interest. The permeate side of the membrane is continuously flushed with water or volatile buffer to remove the effluent ions or adjust the pH. Residence times necessary for adequate removal are generally too long (2-4 minutes) to be practical for use following LC. The rate of diffusion to the capillary wall is limiting, though this can be improved by inserting a filament into the capillary lumen creating a low volume (0.2 μL) device with residence times of 4-12 s. Peptide recoveries from 0.5 mol/L NaCl, however, ranged from 6-78%. Microdialysis capillaries are additionally sensitive to backpressure effects which can increase transmembrane fluid loss or possible rupture of the thin-walled tubes or capillaries.

Microfabrication of isoporous silica membranes of 90 nm thickness have also demonstrated superior performance compared to standard cellulose dialysis membranes. Differences in diffusivity have also been used to extract small molecules from proteins in a laminar flow microfluidic device for selective extraction without a membrane. The higher diffusivity of smaller molecules relative to proteins is thus used for selective extraction without a membrane in the laminar flow microfluidic device. Protein loss is ˜30% upon removal of 90% of the salt, though this value will still be insufficient when large eluent concentrations (>100 mM) are to be used. The rate of ion removal can be accelerated by application of an electric field such as when ion exchange membrane (IEM) suppressors used in IC switched from chemical to electrodialytic regeneration, that is when chemically regenerated IC membrane suppressors were replaced by electrodialytic suppressors. The electromotive force due to the applied voltage increases ion removal through the membrane reducing the necessary length and thus dispersion while simultaneously replacing the acid regenerant with water.

Industrially, electrodialysis with ultrafiltration membranes (UFM) utilize size selective membranes inserted into the electrodialysis stack to isolate the protein containing feed from the IEMs. Addition of the UFM into the membrane stack have been shown to have minimal effect on the overall cell resistance. However, the residual salt, total volume, and treatment time is not currently compatible with LC-MS.

Accordingly, there is a need for economically feasible systems that can be directly coupled to LC systems for the removal of contaminate ions.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter

Generally, embodiments of the technology described herein are directed to systems and methods for analytical size selective electrodialytic desalting. For instance, aspects of the present disclosure can include devices that allow rapid desalting of fluid streams, analysis systems incorporating such devices, and methods of fluid stream desalting that can be incorporated in analysis systems such as coupled liquid chromatography mass spectrometry (LCMS). In particular, implementations of the present disclosure may provide advantages in the analysis of large ionizable molecules (e.g., proteins and oligonucelotides) using electrospray ionization (ESI).

One example aspect includes membrane systems incorporating ion-exchange membranes (IEMs) for removing salts from a fluid stream by applying a potential over the membranes. Another example aspect includes membrane systems incorporating size selective membranes for retaining larger ionizable molecules that might otherwise be removed by ion-exchange systems.

More particularly, the present disclosure is directed to electrodialytic desalination devices (EDDs) including both ion-exchange membranes (IEMs) and size selective membranes (e.g., dialysis membranes (DMs) and or ultrafiltration membranes (UMs)) used in conjunction (e.g., in intimate contact) to obtain high efficiency removal of salts with tolerable dispersion, including of the chromatographically resolved analytes. In some implementations, a single asymmetric or hybrid membrane that possesses both functionalities can be used. For example, a hybrid membrane can be formed by functionalizing a size selective membrane to include ion exchange moieties (e.g., charged moieties). In these implementations, the single asymmetric or hybrid membrane can be used in place of the first ion exchange membrane and the first size-selective membrane. More particularly, for implementations that include one or more ion exchange membranes and one or more size-selective membranes, a hybrid membrane can be used in place of one ion exchange membrane and one size-selective membrane that are in contact.

Implementations of the present disclosure may provide an advantage in methods for the analysis of biomolecules which are important in pharmaceuticals and the life sciences. As one example, biotherapeutics are often present as non-homogenous mixtures, and demonstrating their safety and efficacy can include using multiple separation techniques with qualitative analysis performed by mass spectrometry.

Mass spectrometry (MS), particularly with electrospray ionization, is often incompatible with nonvolatile buffers in the liquid chromatographic (LC) mobile phase. The stability and retention of biomolecules depends frequently upon the mobile phase salt composition, thus separation and detection must be balanced between mobile phase compositions and column type as well as detection sensitivity. Offline methods can be used but are time consuming and may lead to loss of separation resolution.

A further aspect of the present disclosure includes LCMS systems incorporating a membrane system which is fluidically coupled to a liquid stream exiting the LC to produce a desalinated stream that is provided to the MS.

According to some embodiments a membrane system or device is provided. A membrane system or device can comprise a first size selective membrane; a first ion exchange membrane, the first ion exchange membrane being in contact with the first size selective membrane; a second size selective membrane; a second ion exchange membrane, the second ion exchange membrane being in contact with the second size selective membrane; and an effluent channel in fluidic communication with the first size selective membrane and the second size selective membrane. In some instances, the first size selective membrane is positioned between the effluent channel and the first ion exchange membrane, and the second size selective membrane is positioned between the effluent channel and the second ion exchange membrane. In some further instances, the second size selective membrane is positioned on an opposite side of the effluent channel from the first size selective membrane.

According to some further embodiments a method of desalting is provided. A method of desalting can comprise providing a membrane device or system, introducing a fluid stream to the effluent channel of the membrane device or system, and moving the fluid stream through the effluent channel of the membrane device or system to obtain or otherwise produce a desalted stream from the effluent channel of the membrane device or system.

According to some even further embodiments, an analysis system is provided. An analysis system can comprise a liquid chromatograph (LC), a mass spectrometer (MS), and a membrane device or system, where the membrane device or system is positioned in fluidic communication between the LC and the MS.

According to some even further embodiments, a method of fluid analysis is provided. A method of fluid analysis can comprise providing an analysis system, and initially introducing a fluid stream to a separation column of the LC and moving the fluid stream through the separation column to provide or otherwise produce an eluted fluid stream. The method of fluid analysis can further comprise providing or introducing the eluted fluid stream to the effluent channel of the membrane device or system, and moving the eluted fluid stream through the effluent channel of the membrane device or system to provide or otherwise obtain a desalted fluid stream. The method of fluid analysis can even further comprise providing or introducing the desalted fluid stream to an inlet of the MS, and analyzing the desalted fluid stream using the MS.

Additional objects, advantages, and novel features of the technology will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 illustrates an example EDD assembly, in accordance with some aspects of the technology described herein;

FIG. 2 illustrates a graph depicting example data for current and desalted solution conductivity, in accordance with some aspects of the technology described herein;

FIG. 3 illustrates a graph depicting example data for conductance and power, in accordance with some aspects of the technology described herein;

FIG. 4 illustrates graphs depicting example data for conductivity versus applied power, in accordance with some aspects of the technology described herein;

FIG. 5 illustrates graphs depicting example data for dispersion (top) and peak area recovery (bottom), in accordance with some aspects of the technology described herein;

FIG. 6 illustrates mass spectrograms depicting abundance without applied potential (top) and with applied potential (bottom), in accordance with some aspects of the technology described herein;

FIG. 7 illustrates example instrument flow path and electrodes configurations, in accordance with some aspects of the technology described herein;

FIG. 8 illustrates example regenerant effects upon NaOAc desalting on an cation exchange membrane/anion exchange membrane (CEM/AEM) device, in accordance with some aspects of the technology described herein;

FIG. 9 illustrates example regenerant acid flow and concentration effects upon CEM/CEM desalting, in accordance with some aspects of the technology described herein;

FIG. 10 illustrates example conductance of 10-100 mM KNO₃ vs. desalting power on AEM/CEM EDD, in accordance with some aspects of the technology described herein;

FIG. 11 illustrates same as FIG. 10 but using NaOAc, in accordance with some aspects of the technology described herein;

FIG. 12 illustrates same as FIG. 10 but using AmOAc, in accordance with some aspects of the technology described herein;

FIG. 13 illustrates conductance of 10-100 mM KNO₃ vs. desalting power on CEM/CEM EDD, in accordance with some aspects of the technology described herein;

FIG. 14 illustrates same as FIG. 13 but using NaOAc, in accordance with some aspects of the technology described herein;

FIG. 15 illustrates same as FIG. 13 but using AmOAc, in accordance with some aspects of the technology described herein;

FIG. 16 illustrates simulated power distribution of AEM/CEM EDD with deionized water (DIW) as regen at equipotential, in accordance with some aspects of the technology described herein;

FIG. 17 illustrates the same as FIG. 16 but with HNO₃ and KOH used in regen channels, in accordance with some aspects of the technology described herein;

FIG. 18 illustrates simulated KNO₃ remaining vs. total power using stepped voltage screening, in accordance with some aspects of the technology described herein;

FIG. 19 illustrates the same as FIG. 17 but using a voltage profile from FIG. 18, in accordance with some aspects of the technology described herein;

FIG. 20 illustrates the same as FIG. 10 after addition of unfunctionalized DMs, in accordance with some aspects of the technology described herein;

FIG. 21 illustrates the same as FIG. 10 after addition of polymer grafted functionalized DMs, in accordance with some aspects of the technology described herein;

FIG. 22 illustrates the same as FIG. 11 after addition of polymer grafted functionalized DMs, in accordance with some aspects of the technology described herein;

FIG. 23 illustrates the same as FIG. 12 after addition of polymer grafted functionalized DMs, in accordance with some aspects of the technology described herein;

FIG. 24 illustrates the same as FIG. 14 after addition of unfunctionalized DMs, in accordance with some aspects of the technology described herein;

FIG. 25 illustrates the same as FIG. 15 after addition of unfunctionalized DMs, in accordance with some aspects of the technology described herein;

FIG. 26 illustrates example asymmetric energy usage of vinylsulfonated grafted DM using 100 mM AmF, in accordance with some aspects of the technology described herein;

FIG. 27 illustrates the same as FIG. 26 using 100 mM AmOAc, in accordance with some aspects of the technology described herein;

FIG. 28 illustrates the same as FIG. 26 except the DMs are unfunctionalized, in accordance with some aspects of the technology described herein;

FIG. 29 illustrates the same as FIG. 27 except the DMs are unfunctionalized, in accordance with some aspects of the technology described herein;

FIG. 30 illustrates FIAgrams of BSA, Acetone, and HNO₃ in DIW through a union, EDD, or tube, in accordance with some aspects of the technology described herein;

FIG. 31 illustrates example dispersion volumes measured for BSA, Acetone, and HNO₃ on the EDD, and tube, in accordance with some aspects of the technology described herein;

FIG. 32 illustrates example FIAgrams of BSA, Acetone, and HNO₃ in DIW and varying CEM/CEM EDD potential, in accordance with some aspects of the technology described herein;

FIG. 33 illustrates the same as FIG. 30 but with 0-200 mM AmOAc at optimal EDD voltage, in accordance with some aspects of the technology described herein;

FIG. 34 illustrates example Cytochrome-C mass spectra without EDD using 0.1% FA or 50 mm AmOAc carrier, in accordance with some aspects of the technology described herein; and

FIG. 35 illustrates example narrow mass range of Cytochrome-C with and without the EDD, in accordance with some aspects of the technology described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

It is also to be understood that the article “a” or “an” refers to “at least one,” unless the context of a particular use requires otherwise. Additionally, in any disclosed embodiment, the terms “substantially,” “approximately,” and “about” may be used interchangeably.

In general, embodiments of the present technology are directed to systems and/or devices including one or more size selective membranes and one or more ion exchange membranes, methods of applying or implementing such systems and/or devices for the desalination of a fluid stream, analysis systems including such systems and/or devices (e.g., systems including a liquid chromatograph and/or mass spectrometer in fluidic communication with the devices), and methods of fluid analysis.

Size selective membranes and ion exchange membranes in accordance with the present disclosure can include any known in the field based on design principles disclosed herein. Generally, the membranes should display low binding for the analytes of interest, such as proteins and or nucleic acids.

In one example implementation, a fluid stream flowing through an example device may pass through an effluent channel. The effluent channel can contact a first size selective membrane, the size selective membrane positioned between a first ion exchange membrane and the effluent channel. By applying a driving force (e.g., a voltage), the diffusion of ions from the fluid stream through the first size selective membrane and the first ion exchange membrane is altered leading to removal of certain salts from the fluid stream. The properties of the first size selective membrane, can provide retention of larger ions by limiting their diffusion through the membrane. Accordingly, example implementations of the present technology can act to selectively remove salts, for example from a fluid stream, based on the properties and arrangement of the size selective membrane and the ion exchange membrane.

In some instances, implementations of the present disclosure may demonstrate advantages in the pretreatment of samples for analytical or other characterization purposes. For instance, example devices can be coupled to liquid chromatography mass spectrometry (LCMS) systems for salt removal following chromatographic separation, prior to the sample being introduced to the mass spectrometer. Additionally, example devices can be coupled to protein purification methods, for example to remove unwanted salts such as denaturing agents (e.g., guanidinium ions) while retaining most of the protein. Denaturing agents are commonly used to solubilize proteins by unfolding higher-order (e.g., secondary or terternary) structure. However, the denatured form may reduce or eliminate the protein function such as in the case of enzymes and enzyme catalyzed reactions. Thus methods for removing these denaturing agents are also contemplated herein.

According to some embodiments of the technology described herein, a membrane system or device is provided comprising one or more membranes (or membrane systems) configured to be in communication with an effluent channel. In some instances, a membrane system or device comprises a first size selective membrane, a first ion exchange membrane in contact with the first size selective membrane, and an effluent channel in fluidic communication with the first size selective membrane, such that the first size selective membrane is positioned between the effluent channel and the first ion exchange membrane. In some further instances, the membrane system or device comprises a second size selective membrane and a second ion exchange membrane in contact with the second size selective membrane, where the effluent channel is also in fluidic communication with the second size selective membrane, such that the second size selective membrane is positioned between the effluent channel and the second ion exchange membrane, and further such that the second size selective membrane is positioned on an opposite side of the effluent channel from the first size selective membrane. According to some aspects, the first ion exchange membrane and the second ion exchange membrane can be independently selected, for example, the first ion exchange membrane and the second ion exchange membrane can independently be a cation exchange membrane or an anion exchange membrane. Accordingly, in some instances the second ion exchange membrane can be a cation exchange membrane or an anion exchange membrane and the first ion exchange membrane can be the same or different than the second ion exchange membrane.

According to some embodiments, the first size selective membrane and/or second size selective membrane of a membrane system or device can comprise an ultrafiltration membrane or dialysis membrane. In some instances, the first size selective membrane and/or second size selective membrane, for example an ultrafiltration membrane, can have a molecular weight cut off (MWCO) from 0.1-1000 kDA. In some embodiments, an ultrafiltration membrane can have a MWCO of no greater than 15 kDa (or alternatively 15 kDa or less). In some further embodiments, an ultrafiltration membrane can have a MWCO of no less than 0.5 kDa and no greater than 10 kDa (or alternatively from about 0.5 kDa to about 10 kDa). In some even further embodiments, an ultrafiltration membrane can have a MWCO of no less than 0.1 kDa and no greater than 10 kDa (or alternatively from about 0.1 kDa to about 10 kDa).

In some embodiments, a membrane system or device can comprise or include one or more electrodes or pairs of electrodes. For instance, a membrane system or device can comprise a first pair of electrodes positioned on opposite sides of the effluent channel (i.e. a first electrode on a first side of the effluent channel and a second electrode on a second side of the effluent channel). In some example embodiments, a first pair of electrodes comprises an anode and a cathode. A membrane system or device can further comprise n additional pairs of electrodes positioned on opposite sides of the effluent channel, in some instances where n is no less than 1 and no greater than 1000 (i.e. where n is from 1 to 1000). As will be appreciated, then additional pairs of electrodes can be spaced out along the length of the effluent channel, that is the pairs of electrodes can be adjacent to one another and spaced out along the effluent channel. In some instances, the pairs of electrodes can be spaced out at regular or irregular intervals along the effluent channel.

According to some further embodiments, a membrane system or device can comprise an anolyte channel and/or a catholyte channel. In one example embodiment, an anolyte channel can be in fluidic communication with the first ion exchange membrane and a catholyte channel can be in fluidic communication with the second ion exchange membrane. Further the membrane system or device can incorporate an anolyte inlet for providing an anolyte to the anolyte channel, and a catholyte inlet for providing a catholyte to the catholyte channel. As will be appreciated, in some instances the anolyte channel can be in fluidic communication with the second ion exchange membrane and the catholyte channel can be in fluidic communication with the first ion exchange membrane. In the later instance one of skill in the art will also recognize that a configuration of electrode pairs can also be reversed.

According to some other embodiments of the technology described herein, a method of desalting is provided, for example desalting a fluid stream or an effluent stream. In some instances, a method of desalting comprises providing a membrane device or system, introducing or providing a fluid stream to the effluent channel of the membrane device or system, and moving the fluid stream through the effluent channel. The method can further comprise obtaining a desalted stream from the effluent channel of the membrane device or system. In some instances, the fluid stream can comprise at least one of a protein and a denaturant, for example the denaturant can comprise a guanidinium ion or a plurality of ions.

According to some other embodiments of the technology described herein, an analysis system is provided. In some instances, an analysis system can comprise a liquid chromatograph (LC), a mass spectrometer (MS), and a membrane device or system, where the membrane device or system is positioned in fluidic communication between the LC and the MS.

According to some further embodiments, a method of fluid analysis (e.g. via the analysis system) is provided. In some instances, a method of fluid analysis comprises providing an analysis system and introducing a fluid stream to a separation column of a LC and moving the fluid stream through the separation column to provide (or otherwise extract) an eluted fluid stream. Subsequently, the eluted fluid stream can be provided or otherwise introduced to the effluent channel of the membrane device or system of the analysis system. The eluted fluid stream can then be moved through the effluent channel of the membrane system to provide or otherwise extract a desalted fluid stream. The desalted fluid stream can then be provided or introduced to an inlet of a MS and subsequently the MS can be used to analyze the desalted fluid stream. In some embodiments, the separation column of the LC can be an ion exchange column, a reverse phase column, a hydrophilic interaction column, a size exclusion column, or a hydrophobic interaction column.

The fluid stream and/or the eluted fluid stream can in some instances have a flow rate of no less than 0.001 mL/min and no greater than 10 mL/min, or in other words from about 000.1 mL/min to about 10 mL/min. In some embodiments, the fluid stream and/or eluted fluid stream can have a flow rate of about 0.1 mL/min to about 10 mL/min. Further, the residence time of the membrane system can be less than or equal to 30 seconds, or up to 30 seconds, and in some instances, the residence time of the membrane system can be less than or equal to 10 seconds and greater than or equal to 0.5 seconds (in other words from about 0.5 seconds to about 10 seconds).

According to some further embodiments of a method of fluid analysis, the fluid stream can comprise a biomolecule, for example a protein, an oligonucleotide, or both. In some instances, the eluted fluid stream comprises a biomolecule and have a first conductivity, or the eluted fluid stream comprises a biomolecule and one or more salts at a first salt concentration (i.e. a first salt concentration of the one or more slats in the eluted fluid stream). In some further instances, the desalted fluid stream can comprise a biomolecule and have a second conductivity, where the second conductivity is lower than the first conductivity, or the desalted fluid stream can comprise a biomolecule and be free of the one or more salts or comprise the one or more salts at a second salt concentration, where the second salt concentration is lower than the first salt concentration. In some instances, the second conductivity is at least 90% lower than the first conductivity, or the second salt concentration is at least 90% lower than the first salt concentration.

According to some even further embodiments of a method of fluid analysis, the membrane system or device implemented can comprise a first pair of electrodes positioned on opposite sides of the effluent channel and first voltage can be applied to or across the first pair of electrodes. Similar to membrane devices or systems described above, the membrane device or system can further comprise n additional pairs of electrodes positioned on opposite sides of the effluent channel, such that n is no less than 1 and no greater than 1000 (i.e. the n additional pair of electrodes can be from 1 to 1000) and the method further comprises applying n additional voltages (or electric loads) to or across the n additional pairs of electrodes. In some instances, the first voltage can have the same magnitude as one or more of the n additional voltages. In some other instances, the first voltage can have a different magnitude than one or more of the n additional voltages. Additionally, the first voltage and/or the one or more of the n additional voltages can be static or dynamic, and the first voltage and/or one or more of the n additional voltages can be provided by a constant current source.

Embodiments described herein can be understood more readily by reference to the following Examples. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the scope of the disclosure. Accordingly, the present invention will be better understood with reference to the following non-limiting examples with reference to the foregoing drawings.

### EXAMPLES

The following Examples further describe various aspects of embodiments of the present disclosure. These Examples are not meant to limit embodiments solely to such Examples herein, but rather to illustrate some possible implementations.

### Devices, Materials, and Methods

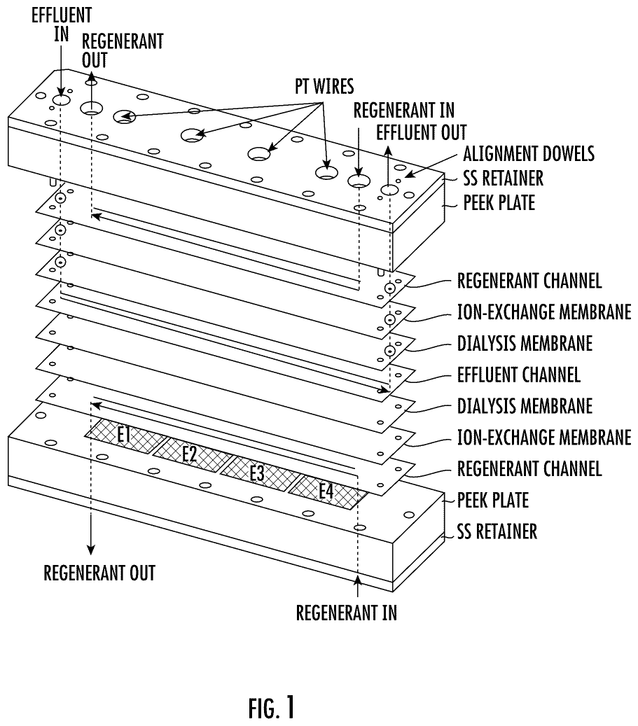

Device Construction. At a high level, an EDD was constructed having components and a configuration as shown in FIG. 1. As illustrated in FIG. 1, the effluent flow channel of the EDD is accessed through 0.5 mm ø holes in the preceding layers, and E1-E4 are the 4 independently controlled electrodes. Between 2 custom machined polyetheretherketone (PEEK) plates was a stack containing 3 flow channels separated by two membrane layers each containing an IEM and DM with the DM oriented towards the central channel and aligned using 4 dowel pins. Both PEEK plates contain ¼-28 ports for regenerant solution inlet and outlet (83 mm apart) while the top plate also contains 10-32 coned eluent ports (102 mm apart); the eluent flows through laser drilled holes in the membranes to reach the central flow channel. The flow channels were constructed either by laser cutting 0.5 mm wide channels into 0.38±0.08 mm thick silicone gasket or using a craft cutter to cut 1.8 mm wide channels in Parafilm™ pressed onto either side of a woven polypropylene mesh (0.25 m thick, 0.25 mm open area). Platinized titanium screens (0.25 mm thick) were inserted into four 2×1 cm recesses (1 mm apart) milled into the PEEK plates. Electrical connection was made through a series of ¼-28 ports machined into each plate. The device was clamped together using stainless steel plates and 4-40 screws. DMs were 6-8 kDa MWCO (SpectraPor1), while CEMs and AEMs (fumasep FKB-125 and FAB-125, respectively) were 125 μm thick with a woven PEEK mesh support.

EDDs were constructed using either two CEM membranes or one each of CEM and AEM. Accordingly, in this section, device arrangements will be referred to as CEM/CEM and CEM/AEM, respectively. All membranes were cut dry and placed into the electrodialysis stack and hydrated in place after assembly.

In some further examples a constructed EDD consisted of 2 sets of DM/IEM pairs and 3 flow channels. DMs (SpectraPor1) had 6-8 kDa MWCO. CEMs and AEMs (fumasep FKB-125 and FAB-125, respectively) were obtained from The Fuel Cell Store and were 125 μm thick with a woven polyetheretherketone (PEEK) mesh support. A 1024 nm NIR laser engraver (FC-20) was used to precision cut the membranes including fluidic ports and alignment holes. Flow channels were constructed from 0.38±0.08 mm thick silicone gasket sheeting or by pressing Parafilm™ onto woven polypropylene mesh (0.25 mm thick, 0.25 mm open area). Silicone sheeting was laser cut to contain 0.5 mm wide channels and necessary porting and alignment holes. Parafilm™ was cut using a Silhouette Cameo 2 craft cutter to contain 1.8 mm wide channels; a single layer was placed on either side of the mesh before sealing the device. The mesh channels add structural rigidity and prevent membrane blockage of the regenerants at high backpressure (>200 psi) such as that due to the ESI-MS inlet; however, dispersion is worse compared to the silicone gasket when used in the central channel. The final design used a combination of mesh channels for the regenerants and a silicone gasket for the effluent. Rectangular electrodes (2×1 cm, 8 total) were laser cut from platinized titanium screen (0.25 mm thick.

Custom PEEK plates were machined as shown in FIG. 1. Recesses for the 4 pairs of electrodes were made in each block with 1 mm spacing between the electrodes. The top block contained an additional 0.6 mm recess for the membranes and gaskets to lay within and four 1.6 mm ø holes for dowel pins to align the membranes and flow channel layers. Standard ¼-28 flat bottomed ports were used for regenerant inlet and outlet separated by 83 mm in both plates. Electrical feedthroughs were also provided using equally spaced ¼-28 ports. One end of 125 μm Pt wires was wrapped around a 0.51 mm Pt clad Nb wire and heat sealed within 1.6 mm O.D. low density polyethylene (LDPE) tubing. The other end of the Pt wire is inserted into the device and fixed in place using ¼-28 nuts and ferrules. The exposed Pt wire is bent under the mesh electrodes which are then adhered to the PEEK by melting strips of Parafilm™ between them with a heat gun. The top block contained standard chromatography 10-32 coned ports for effluent inlet and outlet separated by 102 mm. Stainless Steel (SS) retainer plates (3.175 mm thick) were machined and used to bolt the whole assembly together with 4-40 screws. The assembled device contains 3 flow channels and 4 membranes as shown in FIG. 1. Regenerant solution enters through each side and flows adjacent to the ion exchange membrane counter current to the effluent. The effluent enters the top plate, passes through the top gasket and membrane layers before entering the central channel; the effluent likewise exits through the corresponding membranes prior to detection. EDDs were constructed using either two CEM membranes or one each of CEM and AEM; device arrangements are hereafter referred to as CEM/CEM and CEM/AEM, respectively.

Chemicals and Reagents. All solutions were prepared in deionized water (DIW, ≥18 M (2). All chemicals were reagent grade with the exception of ammonium acetate (AmOAc, ultra-pure), and formic acid (high purity). The EDD regenerant electrolyte was 200 mM HNO₃ unless stated otherwise. The following carriers were prepared: KNO₃, AmOAc, sodium acetate (NaOAc), and ammonium formate (AmF) each at concentrations of 1 M and 0.1 Mas well as DIW and 0.1% formic acid. AmF was prepared from formic acid and neutralized with NH₄OH to pH 6-7 as indicated by Hydrion pH paper (pH 0-13). Cytochrome C from chicken heart and Bovine Serum Albumin (Fraction V) were dissolved at 10 μg/mL and 1 mg/mL, respectively in DIW and kept up to 1 week at 4° C. Samples were prepared by diluting in appropriate mobile phase combinations prior to analysis. Rinsing of DMs was carried out by dissolving salts of NaHCO₃, Na₂EDTA, oxalic acid, HCl, and NaOH in DIW. Functionalization of DMs was performed by polymerization of 25% sodium vinyl sulfonate (VS, as supplied) or 40% 2-(Dimethylamino)ethyl methacrylate (DMAEMA, diluted from 100% in DIW). Fenton's reagent prepared from Fe (NH₄)₂ (SO₄)₂·6H₂O and 30% H₂O₂, was used as polymerization initiator. Dialysis Membrane Functionalization.

DMs were thoroughly cleaned by soaking in 2% NaHCO₃ and 1 mM EDTA, DIW, acetone and finally DIW again for 1 hour each. Aqueous and acetone rinses were performed at 90° C. and 50° C., respectively in a convection oven. For graft polymerization DMs were then soaked in N₂ purged 0.2% w/v ferrous ammonium sulfate hexahydrate (FAS, Fe(NH₄)₂ (SO₄)₂·6H₂O) at 30° C. for 30 minutes. Monomer solutions of 25% sodium vinylsulfonate and 40% DMAEMA were purged with nitrogen and placed in airtight amber glass bottles. DMs were removed from the FAS solution, quickly dipped in DIW to remove excess FAS and submerged in the monomer solution. The monomer solution was spiked with H₂O₂ to a final concentration of 2 mM. The H₂O₂ reacts with the ferrous iron which is adsorbed to the negative DM surface forming the radical initiator (Fenton's reagent). The solution was purged again with nitrogen before sealing and placing in a 50° C. convection oven for 24 hours. DMs were removed from the monomer solution and rinsed with DIW at 90° C. followed by 2% oxalic acid, 10 mM HCl, and 10 mM NaOH and finally DIW at room temperature for minimally 2 hours each. After cleaning, the functionalized or unfunctionalized DMs were then wound on a spool and dried at 60° C. and kept in a desiccator till use. The membranes were laser cut dry (including ports, and alignment holes) before insertion into the device stack.

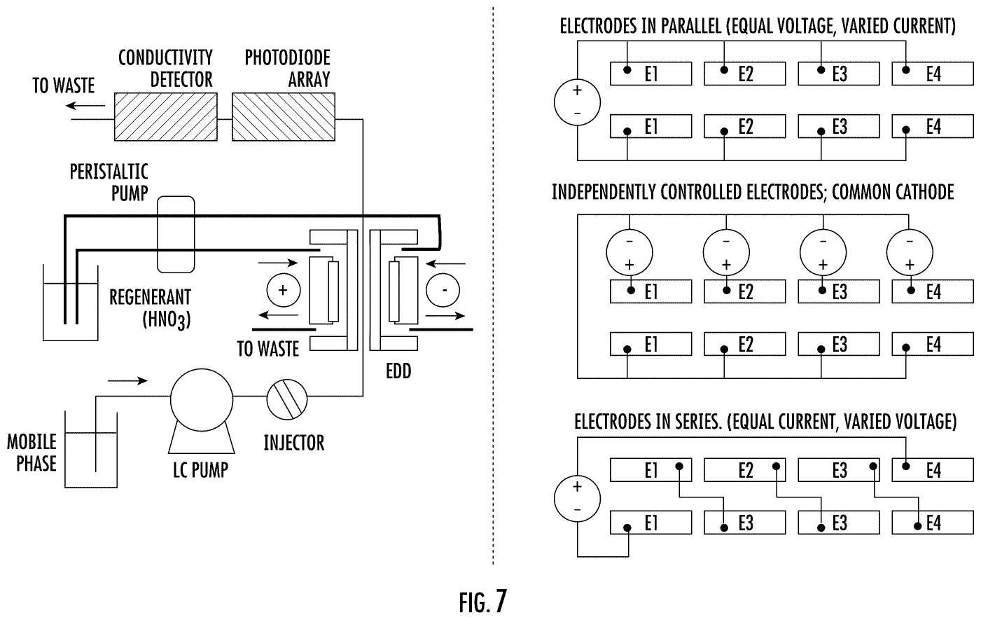

Instrumentation. A Rainin Dynamax peristaltic pump was used to deliver ˜0.75 mL/min of regen electrolyte to each channel of the EDD counter current to the mobile phase unless stated otherwise. The system and flow path (see also FIG. 7) consisted of Thermo Surveyor LC-Pump and Autosampler with 5 5 μL Injector, the EDD, a Dionex PDA-100, and an ICS-5000 or CD25 conductivity detector (both Dionex). System control and acquisition was performed in Chromeleon 6.8. A Waters TQ-XS triple quadrupole MS instrument (Waters, Milford, MA) was used to acquire mass spectrograms (positive mode, 700-1800 m/z scan range) of 10 μg/mL cytochrome C infused directly through the EDD into the MS at 100 μL/min; the regenerant was 1% formic acid flowing at 200 μL/min split to both channels. Both pumps were Acquity I-Class UPLC pumps (Waters, Milford, MA).

Salt Removal Measurements. For each salt and concentration, current-voltage profiles were measured by wiring the anodes and cathodes in parallel, applying a potential, and measuring the current through each electrode pair using a multimeter; conductance measurements were recorded after the reading had stabilized. The following electrode arrangements were also tested on a more limited basis: 1) a step potential increasing from inlet to outlet 2) electrodes connected in series providing equal current at each electrode pair and 3) voltage and current readings were used to manually power match electrodes 3-4 to electrode 1. Arrangements 1 and 3 used a common cathode.

Wiring diagrams are shown in FIG. 7. As can be seen in FIG. 7 Left) Instrument Flow Path Diagram. HNO₃ is delivered by a peristaltic pump to the regenerant channels of the EDD while the mobile phase passes through the central channel. Right) Electrode wiring diagrams. For electrodes wired in parallel (top), a single supply is used and each electrode pair is maintained at the same potential, henceforth referred to as equipotential; the current flowing through each pair depends upon the resistance through that region and is measured by placing a multimeter in series between each electrode and the common cathode. This was the standard configuration used throughout this work unless stated otherwise. The same arrangement may be used with constant current supplies as is done with commercial ion chromatography electrodialytic suppressors. Even in the constant current operational mode, the voltage across each pair of electrodes is the same, but the current through the electrodes varies with the sum of the individual currents totaling the supplied current. The middle wiring diagram uses 4 independently controlled voltage supplies and current monitoring with a multimeter in series at each cathode to manually balance the power load along the device. The lower wiring scheme shows the electrodes connected in series; the same current flows through each pair of electrodes but the potential across the electrode depends upon the resistance between those electrodes. A multimeter is used to measure the current in series between the E1 cathode and the power supply; voltage is measured in parallel across each electrode pair. As ions are removed, the solution conductance drops; to maintain current the voltage across this region increases. This arrangement leads to a natural voltage step profile along the device. The power consumed at each electrode pair regardless of the arrangement was computed from the current flowing through the electrodes and the measured voltage across each electrode pair.

Dispersion Analysis. Dispersion through the device was measured by injecting 3 analytes: 0.1% v/v Acetone, 100 μg/mL BSA, and 10 mM HNO₃ through the EDD and compared to a zero dead volume PEEK union (0.01″ through hole) using absorbance at 280 nm for Acetone and BSA and 254 nm for HNO₃ from 0.1-1.0 mL/min without load. Analyte dispersion was also measured at 0.25 mL/min at various applied potentials in DIW and under optimal load with various concentrations of AmOAc.

Simulation CEM/AEM Ion Transfer. A simulation was developed to better understand the energy distribution in each of the flow channels and membranes. Membrane resistances were taken from the manufacturer specifications: 7 and 3.75 Ω*cm⁻² for AEM and CEM respectively and are not necessarily representative of the present salt and conditions. KNO₃ conductance is nonlinear with concentration. Concentrations up to 100 mM were measured and a quadratic fit was applied μS/cm=−115397*[KNO₃]²+119347*[KNO₃]+0.7142 (concentration in molar units). The intercept was forced to 0.7142 μS/cm, the value of DIW exposed to laboratory atmosphere. The electrode solutions KOH (anolyte) and HNO₃ (catholyte) generated after ion removal were not so measured but the quadratic equation determined for KNO₃ was assumed to represent the appropriate curvature and the coefficients scaled by the limiting ionic conductivities as an approximation. Initial feed concentrations of electrode solutions could also be varied. All channel dimensions were 8 cm long, 500 μm wide, and 300 μm deep. The effluent and regenerant flow rates were 0.25 and 0.75 mL/min respectively. The four electrode voltages are configured independently or allowed to step through various combinations as a factor of the preceding electrode. The system may be treated as any number of slices; 1000 slices were used to produce smooth curves, while 200 slices were used to increase computation speed when testing a variety of stepped voltages. A simple ohmic model was used to determine ion transfer. The resistance through each slice was first determined and the current computed from Ohm's law (I=V/R). The current and resistance at each layer were then used to determine the power dissipated (P=I²*R) in each membrane or flow channel. The residence time in each slice determined from the flow rate and channel volumes was used to determine the total charge passing through the slice. Assuming 100% Faradaic efficiency, the charge was converted into moles of ions transferred from the effluent into the electrode streams. The concentration was diluted in the regenerant by the ratio of the flows through each. Each slice was then moved in the direction of the flow with new regen and effluent entering at the initial positions. The simulation was carried out over multiple channel volumes to establish a steady state since initial electrode solution was DIW; 2-4 volumes provided sufficiently accurate results. Energy distribution data is provided in mW/mm to provide comparable data if using different slice widths in the simulation.

### Results and Discussion

Electrodialytic Operation Principles. Not intending to be bound by theory, it is believed the CEM/CEM device behaves according to similar principles as electrodialytic membrane suppressors used in anion exchange IC. Water electrolysis at the anode generates H (H₂O-2e⁻→2H⁺+½ O₂) which passes through the first CEM to displace the effluent cation such as Na⁺ through the opposing CEM converting the eluent anion into the corresponding acid (e.g. NaOAc to HOAc). The displaced cation then forms the respective base, e.g. NaOH, at the cathode (2 H₂O+2e⁻→H₂+2 OH⁻) which flows to waste. When the eluent anion is a weak acid, it is neutralized by H resulting in a lower conductance background. The device current (and power) efficiency decreases with increasing anion strength due to competitive transport between H⁺ and the eluent cation; further exacerbated by the >4× higher ionic conductance of H⁺ over other cations. Anion transport is prohibited due to the negative surface charge of the CEM. In the CEM/AEM, salt splits in the central channel. Anions are removed through the AEM forming their respective acid at the anode, while cations conversely are removed through the CEM forming their respective base at the cathode. Ideally, the effluent is DIW, though water splitting in the channel may lead to preferential removal of one ion over the other.

Again, not intending to be bound by theory, it is believed the AEM/CEM device works by splitting the salt in the effluent channels with the anode and cathode respectively positioned adjacent the AEM and CEM. Anions and cations are removed through the AEM and CEM respectively forming the respective acid and salt due to water electrolysis. In some preferred instances, the effluent output is DIW, though water splitting at one of the membranes may lead to preferential removal of one ion of the other.

As will be appreciated, while these devices are referred to as suppressors and the effluent is suppressed, this can lead to confusion when discussing MS signal suppression. As such, EDD's are often referred to herein as a desalinator and refer to the eluent as desalted even referring to solely cation removal, while retaining suppressed and suppression with regard to MS signals.

Choice of Effluent Salts. The salts KNO₃, NaOAc, and AmOAc were chosen as electrodialytically friendly electrolytes of strong and weak acids and bases. Commonly, NaCl is used as a neutral strong electrolyte; however, removal of Cl⁻ through an AEM to the anode compartment may lead to formation of Cl₂ or HOCl which could degrade the membrane reducing performance over time; alternatively, AEMs with high oxidative stability or a CEM to isolate the AEM from the anode may be used. KNO₃ is preferred to NaNO₃ due to the higher equivalent conductance of K⁺ relative to Na⁺ (73.48 and 50.08 μS/cm·mM, respectively) lowering the energy required for removal. Additionally, NO₃⁻ (71.42 μS/cm·mM) conductance is closely matched to that of K. The two acetate salts have the advantage of forming MS compatible HOAC in a CEM/CEM EDD.

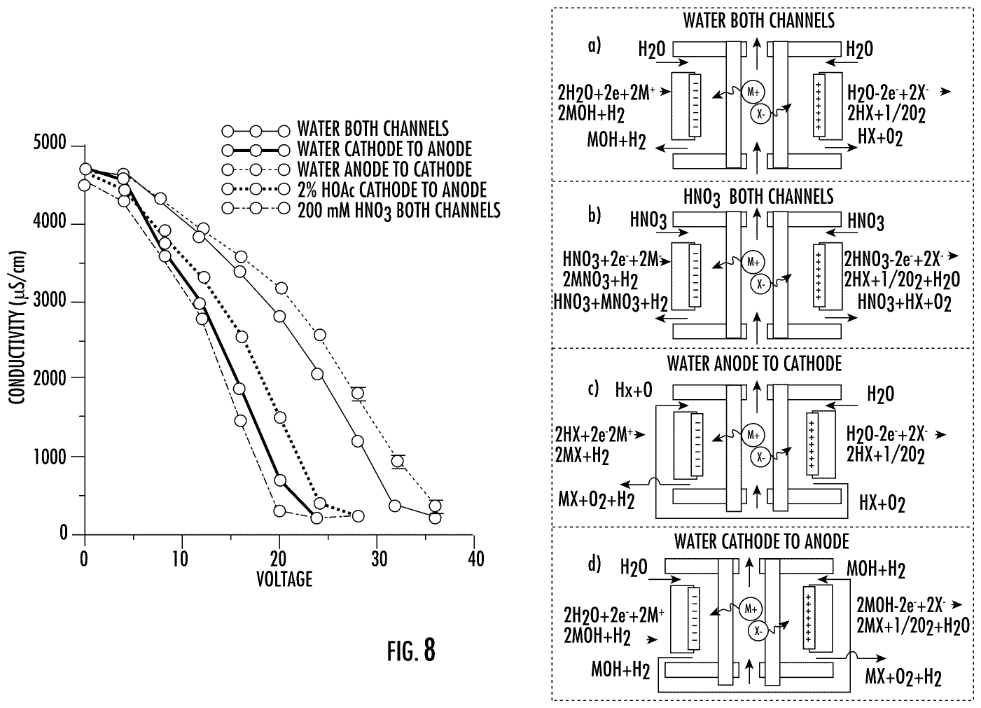

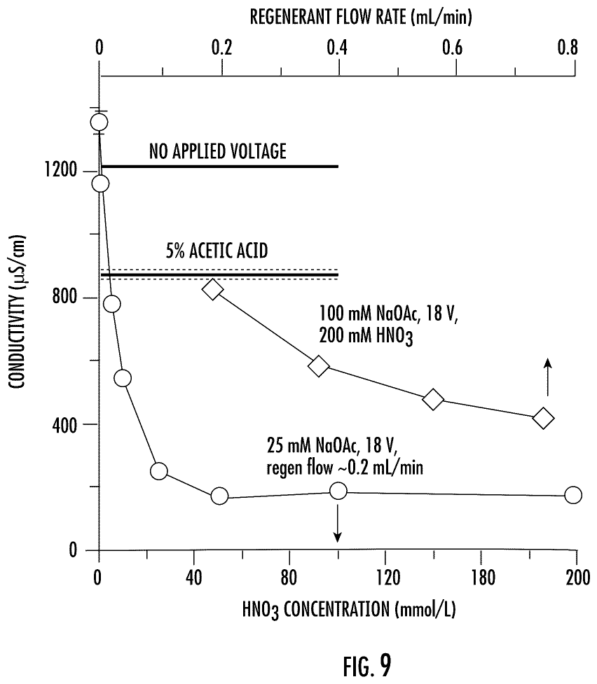

Regenerant Solution. The role of the electrolyte in the electrode flow channels was investigated particularly for the CEM/AEM EDD and are shown in FIGS. 8-9. As can be seen, 200 mM HNO₃ flowing at 0.75 mL/min through both channels provided optimal results for both EDDs. The acid lowers the resistance in the electrode compartment reducing the desalting power. The CEM/AEM may be operated using only DIW due to the formation of conductive products in the electrode chambers with results comparable to HNO₃ (FIG. 8); however, this depends upon the salt used and flow configuration (e.g. flowing from anode to cathode or vice versa). No increase in background conductance was observed after desalting (FIGS. 8-9) up to 200 mM HNO₃ indicating penetration through the IEMs was negligible. Functionalized screens in the regenerant may be used alternatively to lower the resistance.

Referring to FIGS. 8 and 9, FIG. 8 illustrates Left) Conductivity of 100 mM NaOAc flowing at 0.25 mL/min through the CEM/AEM device at various applied potentials and with different regenerant solutions and flow configurations. Right) flow configuration used and electrochemical reactions in each regenerant compartment. Water electrolysis at the electrodes provides a near infinite reserve of H⁺ and OH regenerant so long as produced gases are removed. DIW delivered in parallel to the regenerant and counter current the effluent stream (configuration a) results in a conductance profile mirroring that of the effluent, decreasing along the device from effluent inlet to exit. Effluent salt and flow configuration of the DIW have a profound effect upon the voltage required for complete desalting as seen in the top panel. Using NaOAc, a highly conductive strong base solution is formed at the cathode while partial dissociation of HOAc at the cathode results in significantly lower conductance. The regenerant may also be pumped serially from one compartment to the other (configurations c and d). For NaOAc, water in both channels (second from top line) was slightly better than flowing from anode to cathode (top line) while reversing the flow from cathode to anode (second from bottom line) resulted in ˜33% decrease in the required voltage. When flowing from anode to cathode (c), the anode compartment conductance due to partially dissociated HOAc is unchanged from using DIW in both channels (a); however, the cathode compartment conductance decreases since highly conductive NaOH is no longer formed but rather NaOAc. The cathode to anode arrangement (d) maintains the high conductivity NaOH in the cathode and increases the conductance in the anode compartment by forming the salt over the partially ionized HOAc. This was confirmed by using 2% HOAc in the same arrangement which resulted in an increase in the voltage necessary for complete removal (middle line). Pumping 200 mM HNO₃ through the outer channels (b, bottom line) is only marginally better than DIW flowing from cathode to anode (d) for NaOAc. Chemical exchange only accounted for <3% decrease in starting conductance. Orientation is less important for strong electrolytes, but the use of anode to cathode (c) is necessary for weak base/strong acid (e.g. NH₄Cl) while weak acid/weak base will require a strong electrolyte (e.g. HNO₃) as feed.

Referring to FIG. 9, FIG. 9 shows CEM/CEM regenerant parameter optimization for NaOAc flowing through the device at 0.25 mL/min. For the CEM/CEM EDD, an acid must be used minimally flowing through the anode with H being regenerated by electrolysis. At the cathode, OH is formed and rapidly increases the conductivity (H⁺ and OH are the two most conductive ions at 349.65 and 198 μS/cm/mM, respectively), though this is less effective if the cation to be removed is a weak base such as NH₄⁺. HNO₃ was chosen to circulate through both channels. Note, the anode solution should remain uncontaminated and may be recycled back into the HNO₃ reservoir for electrolytic gas removal. The bottom line corresponds to the HNO₃ concentration (lower abscissa) and the top line is the regenerant flow rate (upper abscissa). Concentrations of NaOAc in each case were 25 and 100 mM respectively. A static 18 Volts was applied and the conductance monitored for changes. Regen flow, when measuring concentration effects was 0.2 mL/min. No discernible desalting was had using just water flowing through the device due to the high resistance in the electrode channels. As the acid concentration is increased, current flow increases and the conductivity drops to a minimum before a slight increase where conversion to HOAc is complete. The minimum HNO₃ concentration that provided complete desalting of 25 mM NaOAc was 100 mM; as such 200 mM was used for the remainder of the experiments to provide adequate desalting for higher eluent concentrations. For reference, 5% HOAc was also used as the regenerant (average: lower solidline+/−1 standard deviation dashed lines) but was not suitably ionized to obtain sufficient desalination. The lower horizontal line is the conductivity without voltage applied for 200 mM HNO₃; chemical ion exchange results in a ˜10% decrease in conductance. The NaOAc was increased to 100 mM and the effect of the regenerant flow rate was tested. Some modest improvements were had as the electrolytic gases were cleared more rapidly and formation of NaNO₃ was minimized in the cathode chamber. Note that a decrease in residual conductivity from 824 to 414 μS/cm only equates to a decrease of 9% of the starting conductivity (˜4700 μS/cm). Unless stated otherwise, 200 mM HNO₃ flowing at 0.75 mL/min through each channel was used as the optimal regenerant.

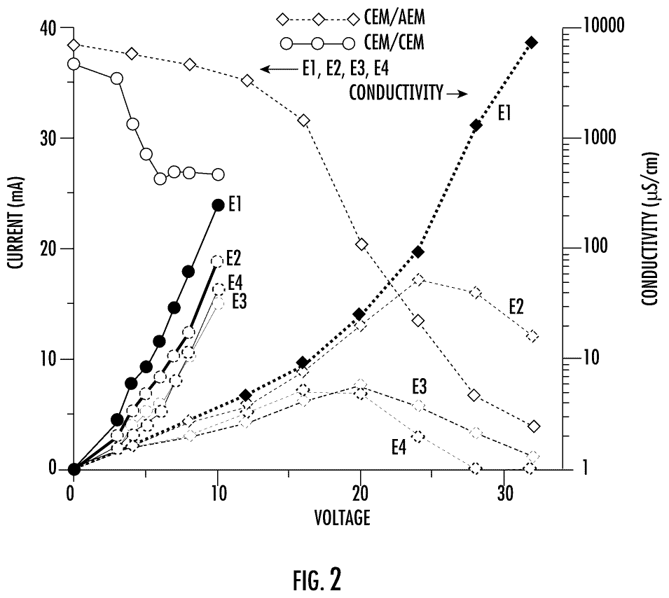

Electrical Behavior. Devices were characterized initially without DMs; FIG. 2 shows the current through each electrode pair and effluent conductance of 100 mM NH₄OAc for both EDDs as the voltage is stepped up. For the CEM/CEM, current is approximately linear with voltage and evenly distributed amongst electrodes. For the CEM/AEM, current at each electrode pair increases to a maximum before decreasing due to the reduced effluent conductance as salt is removed. The voltage at which the maxima occurs increases with proximity to the inlet. Localized heating at the inlet results in eventual failure at high salt loads. The conductivity of the CEM/CEM is characteristic of an effluent containing a weak acid. Due to the AmOAc buffering, H⁺ concentration remains largely unchanged; when NH₄⁺ is depleted, the pH decreases while conductance increases due to the higher conductivity of H. For the CEM/AEM, the conductivity continues to decrease with voltage. If conductivity is due entirely to AmOAc, the removal efficiency is 99.98% at the highest voltage tested. Faradaic efficiency was determined from the nominal current required for desalting assuming 1 electron per cation or cation/anion pair, FE=Iₙₒₘᵢₙₐₗ/I_{measured}*100. For the CEM/AEM, FE was determined for residual concentrations≤1 mM (114.4 μS/cm/mM for AmOAc) and decreased from 96% to 77% from 20-32 Volts. The field strength may exceed 80 kV/m if the entirety of the voltage drop is across the central channel leading to enhanced water splitting²⁵ and reducing the efficiency as H⁺ and OH become the dominant charge carriers. For the CEM/CEM, the FE was 98% at the start of the plateau and decreases at excess voltages. Due to the high FE and low resistance, CEM/CEM devices are typically operated at constant currents above the minimum necessary for desalting. For the CEM/AEM however, excess currents lead to heating near the inlet and eventual damage, and operation should be limited to voltage control. As illustrated in FIG. 2, current at electrodes E1-E4 (numbered from inlet to outlet, left ordinate) and solution conductance (right ordinate) of 100 mM NH₄OAc flowing at 0.25 mL/min through CEM/CEM (circles and solid lines) and CEM/AEM (diamonds and dashed lines) devices as voltage is increased. 200 mM HNO₃ as regenerant is flowed from cathode to anode at 0.75 mL/min.

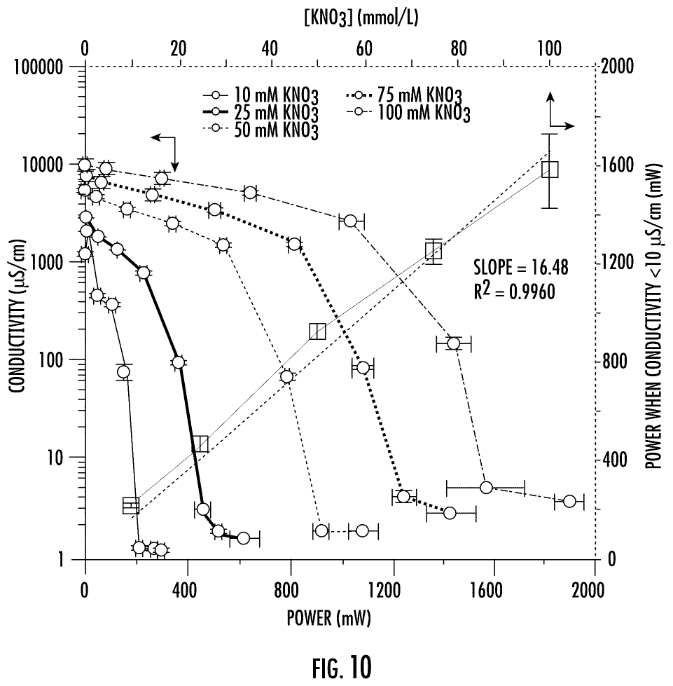

Total power usage (V*I) was computed for each salt at 5 concentrations from 10-100 mM on both devices; (FIGS. 10-15). The degree to which desalting must be achieved will depend upon the application, as used in these examples, near complete removal or conversion of the salt which likely exceeds practical requirements has been selected as a degree of desalting. The CEM/CEM behaves as expected; AmOAc and NaOAc yield a lower conductivity HOAc while KNO₃ produces highly conductive HNO₃. The minimum power required for desalting the OAc salts (at the conductance minimum), was linear (R²≥0.99) with concentration. Energy usage was 34% greater for NaOAc than AmOAc (584±78 and 436±30 KJ/mol, respectively) due to the 32% lower conductivity of Na.

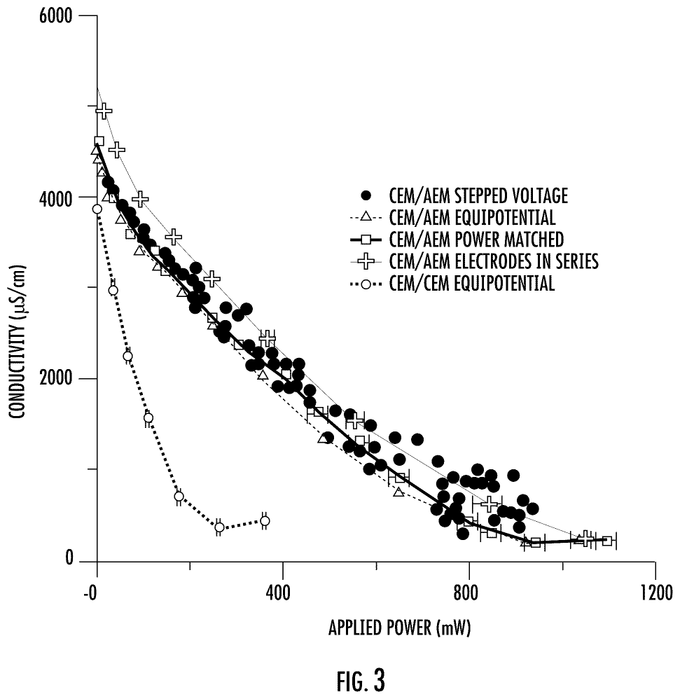

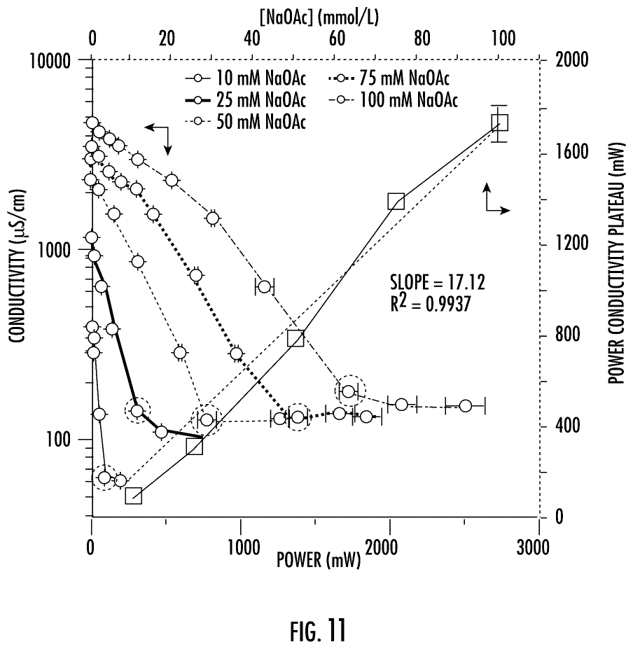

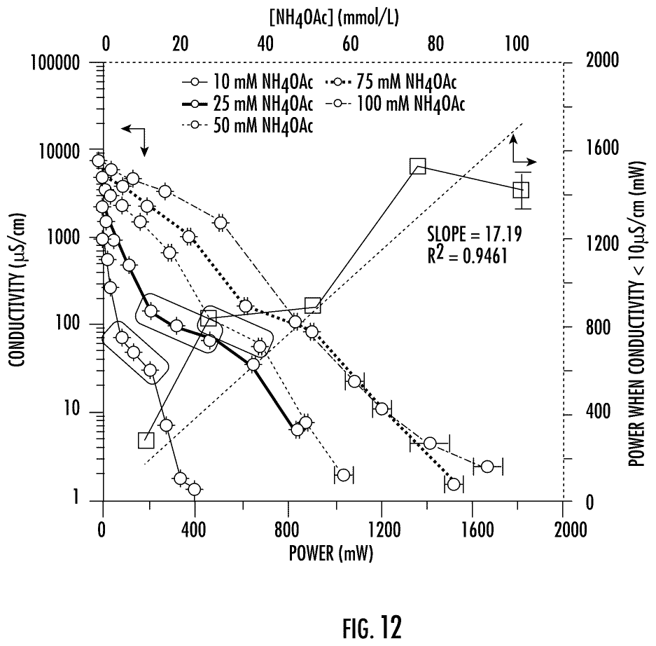

Results for the CEM/AEM device are more complicated. KNO₃ behaves ideally; power demand increases linearly (R²=0.9960) with concentration at 3960±350 KJ/mol (desalting was considered complete when the conductivity went below 10 μS/cm, equivalent to <0.07 mM KNO₃). For NaOAc, water splitting occurs producing HOAc forming a conductivity plateau that increase with concentration (FIG. 11); though the amount of OAc⁻ removed increases from 60-84% for 10-100 mM NaOAc. Energy required was 4108±460 KJ/mol. For AmOAc, complete desalting was possible though peculiar trends in the conductivity plots were observed possibly indicative of water splitting (FIG. 12); desalting required 4100±1400 KJ/mol. No statistical difference is observed between desalting energies indicating ion conductance in solution or through the membrane is insignificant relevant to that necessary for charge separation which is ˜10× higher than the CEM/CEM. Chen et al. constructed a micro CEM/AEM using IEM discs; desalting 200 mM NaCl at 1 μL/min required 21,000 KJ/mol.²⁵ The 5× greater power demand is in keeping with the 6× lower volume of their device, though the present configuration is suitable for 100× the flow. Packing the channel with IEX resins as is done in electrodeionization may lower the energy, but novel materials would be needed to prevent analyte binding such as restricted access media with internal ion exchangers. Referring to FIG. 3, FIG. 3 illustrates solution conductance and power consumption of EDDs using several voltage/current profiles; (see FIG. 7 for electrode wiring). Effluent is 100 mM NaOAc at 0.25 mL/min. The CEM/AEM device uses DIW flowing from cathode to anode as the regenerant. Conditions for the CEM/CEM are same as in FIG. 2.

Referring to FIG. 10 showing power required for desalting of various concentrations of KNO₃ on a CEM/AEM device. Power was computed using the measured voltage and sum of current from all 4 electrodes; error is due to the measured current fluctuations. The power vs the solution conductance uses the lower abscissa and left ordinate, respectively for the various solution concentrations. A threshold of 10 μS/cm was used to determine the cutoff at which the solution was considered desalted and the power where the solution first dips below this level is plotted vs the concentration: right ordinate and top abscissa respectively. The power required for desalting is approximately linear with concentration; dashed line is the best fit forced through the origin. Electrodes were operated at equipotential. Conditions are the same as FIG. 2. For the flow rate of 0.25 mL/min, a total energy of 3960±350 KJ/mol is required for removal. For context, if all the energy were confined to heating the effluent, at the present flow rate the temperature rise would be ˜0.95° C./mM.

Referring to FIG. 11 showing power required for desalting of various concentrations of NaOAc on a CEM/AEM device. The power vs the solution conductance uses the lower abscissa and left ordinate, respectively for the various solution concentrations. No arbitrary threshold was observed where desalting could be considered complete as in FIG. 10. Instead, the first point near the plateau vertex was used and is circled. This power is plotted vs the concentration: right ordinate and top abscissa respectively. The power required for desalting is approximately linear with concentration. Electrodes were operated at equipotential. Water splitting results in preferential removal of Na over OAc leading to formation of HOAc in the effluent channel and a higher background than when KNO₃ is desalted. Conditions are the same as FIG. 2. For the effluent flow rate of 0.25 mL/min, a total energy of 4108±460 KJ/mol is required for removal. For context, if all the energy were confined to heating the effluent, at the present flow rate the temperature rise would be ˜0.98° C./mM.

Referring to FIG. 12 showing power required for desalting of various concentrations of AmOAc on a CEM/AEM EDD. The power vs the solution conductance uses the lower abscissa and left ordinate, respectively for the various solution concentrations. A threshold of 10 μS/cm was used to determine the cutoff at which the solution was considered desalted and the power where the solution first dips below this level is plotted vs the concentration: right ordinate and top abscissa respectively. The linear relationship was poorer than in FIGS. 10 and 11 as a result of the unusual removal profiles particularly evident for the low concentrations of 10-50 mM; note the flatter region (red highlight) where the drop in conductance is slower than that observed in FIGS. 10 and 11. This effect is concentration dependent and has disappeared by 100 mM. Note that power removal regardless of salt is essentially the same at 100 mM in S4-S6. Electrodes were operated at equipotential. Conditions are the same as FIG. 2. For the flow rate of 0.25 mL/min, a total energy of 4100±1400 KJ/mol is required for removal. For context, if all the energy were confined to heating the effluent, at the present flow rate the temperature rise would be ˜0.99° C./mM.

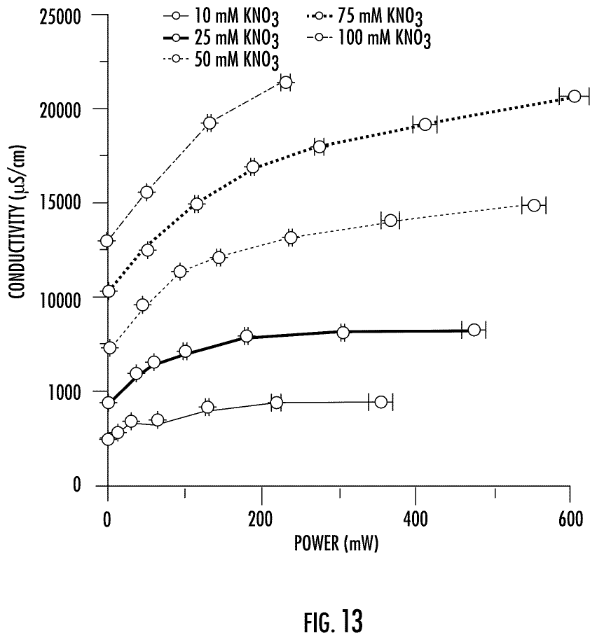

Referring to FIG. 13 showing power required for acid conversion of various concentrations of KNO₃ on a CEM/CEM device. KNO₃ forms the more conductive HNO₃. Removal of K⁺ becomes increasingly difficult due to competitive transport of the more conductive H⁺. Conditions are the same as FIG. 2.

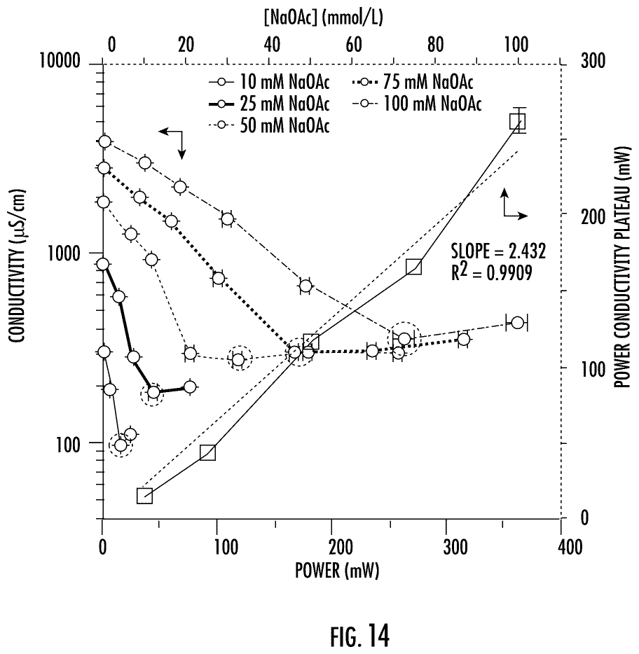

Referring to FIG. 14 showing power required for desalting of various concentrations of NaOAc on a CEM/CEM EDD. The power vs the solution conductance uses the lower abscissa and left ordinate, respectively for the various solution concentrations. No threshold was observed where desalting could be considered complete as in FIG. 10. Instead, the first point at or after the plateau vertex was used and is circled. This power is plotted vs the concentration: right ordinate and top abscissa respectively; the power required for desalting is approximately linear with concentration. The dashed line represents the best fit. Electrodes were operated at equipotential. Conditions are the same as FIG. 2. For the flow rate of 0.25 mL/min, a total energy of 584±78 kJ/mol is required for removal. For context, if all the energy were confined to heating the effluent, at the present flow rate the temperature rise would be ˜0.14° C./mM.

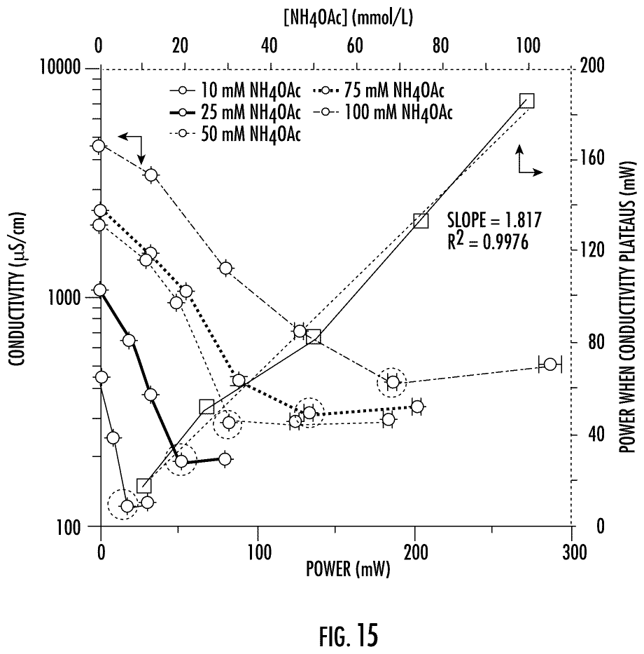

Referring to FIG. 15 showing power required for desalting of various concentrations of AmOAc on a CEM/CEM EDD. The power vs the solution conductance uses the lower abscissa and left ordinate, respectively for the various solution concentrations. No threshold was observed where desalting could be considered complete as in FIG. 10. Instead, the first point at or after the plateau vertex was used and is circled. This power is plotted vs the concentration: right ordinate and top abscissa respectively; the power required for desalting is approximately linear with concentration shown with the dashed best fit line. Electrodes were operated at equipotential. Conditions are the same as FIG. 2. For context, if all the energy were confined to heating the effluent, at the present flow rate the temperature rise would be ˜0.10° C./mM.

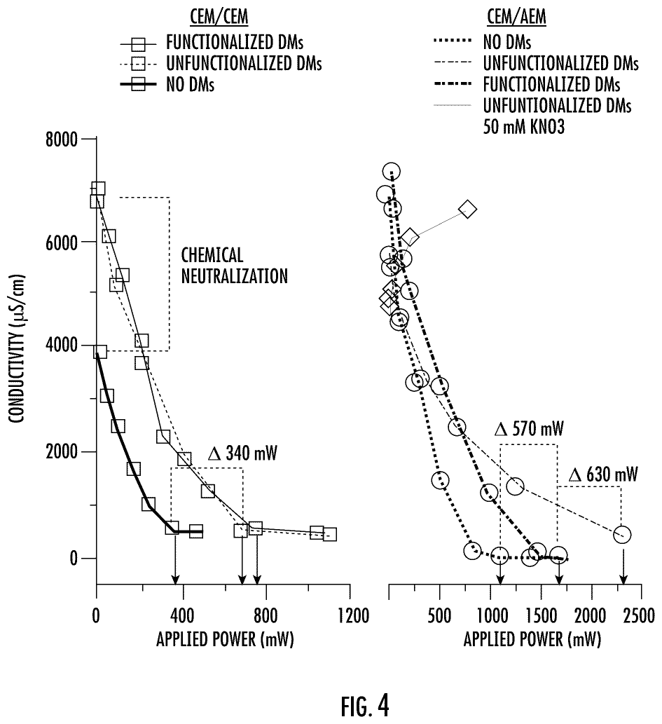

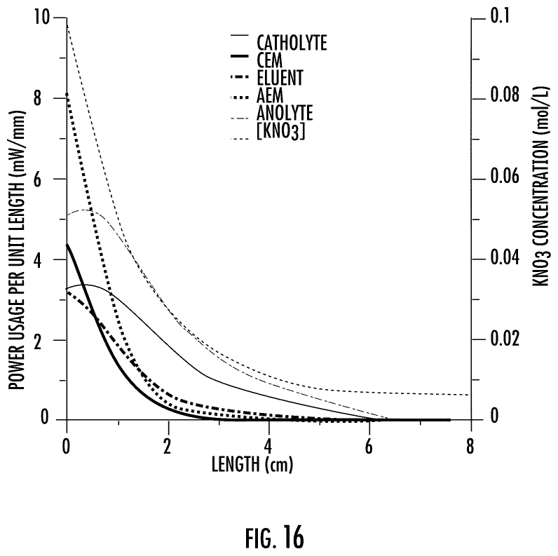

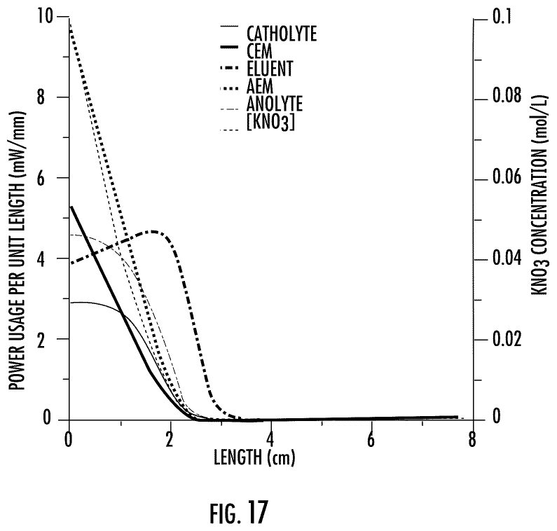

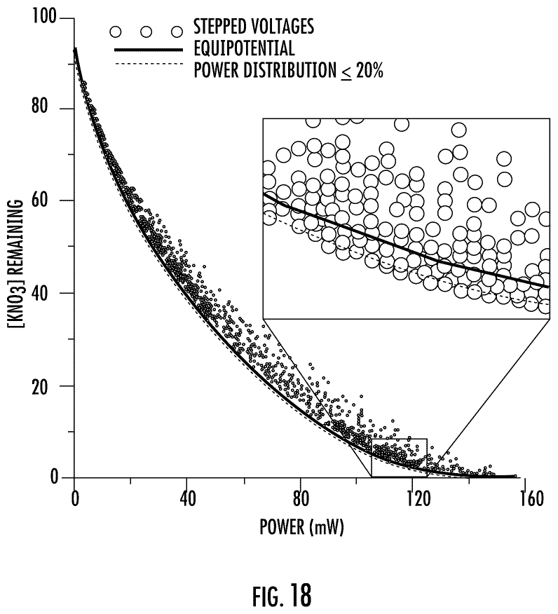

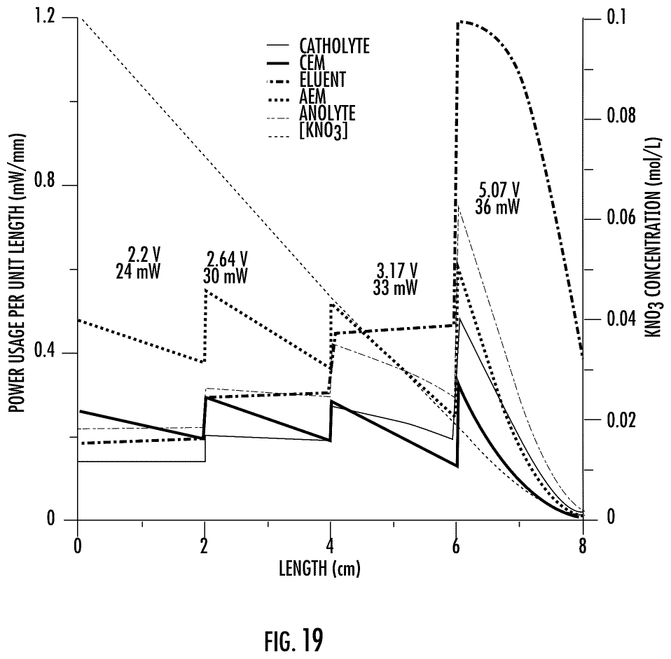

The high energy demand for the CEM/AEM is localized predominantly at the first electrode (FIG. 2) where solution conductance is highest; heating may lead to membrane damage or be detrimental for thermally labile analytes. The voltage was stepped up at subsequent electrodes to better distribute the power/heat; a simple ohmic model was also used to simulate the process. The model confirmed energy usage was greatest near the effluent inlet (FIGS. 16 and 17). The simulation was used to screen a variety of stepped voltage combinations 1-2 times the preceding electrode. Regardless of the step profile, total power consumed is relatively uniform (FIG. 18), though the minimum power occurs when most evenly distributed across the device (% RSD<=20% for E1-E4) resulting in near linear removal of KNO₃ along the device (FIG. 19). The same trend was observed on the actual CEM/AEM using stepped voltages for NaOAc (FIG. 3) albeit at almost 10× higher power demand than predicted by the model. Energy requirements are near uniform regardless of the step voltage distribution. E1-E4 were power matched using independently controlled supplies (% RSD was <7%). Power consumption was similar to equipotential; indicating electrode cross-talk is negligible. Connecting the electrodes in series using only a single supply results in constant current at each electrode pair. As the effluent conductance decreases near the outlet, the voltage will increase to maintain the current resulting in a stepped voltage profile. Power % RSDs were always <24% and were <10% near the desalting threshold; no significant difference in total power consumed was observed relative to the other arrangements. Conversely, equipotential operation % RSD was always ≥19% and 40% at the desalting threshold. To improve membrane longevity, stepped potential operation is recommended. FIG. 4 illustrates desalting comparison of 100 mM AmOAc with and without unfunctionalized or functionalized DMs: Left) the CEM/CEM EDD and Right) the CEM/AEM EDD including 50 mM KNO₃. KNO₃ conductance increases due to HNO₃ formation caused by water splitting at the DM-AEM interface.

Referring briefly to the FIGS., 16 and 17 show the energy distribution in the CEM/AEM device under the same conditions except the electrode solution in FIG. 17 contains 10 mM of HNO₃ or KOH initially in the anode and cathode channels respectively. Removal of KNO₃ is more complete when the electrode channels are first seeded with HNO₃ and KOH for reasons described in FIG. 8. However, the majority of the energy is focused in a 2 cm section at the inlet of the device. FIG. 18 is the voltage screening and total power measured thereof. Data were sorted as equipotential or by using % RSD of the power consumed at each electrode pair to obtain those with near uniform distribution (% RSD<20%); the resultant lines are plotted. FIG. 19 shows a device with near uniform power distribution at the desalting threshold that was selected from the voltage screening in FIG. 18.

As illustrated, FIG. 16 shows simulated power distribution (left ordinate) and KNO₃ removal (right ordinate) along the length of an 8 cm of an AEM/CM device at equipotential. Effluent Flow=0.25 mL/min, regen flow=0.75 mL/min counter current to eluent, 10V applied at all 4 electrodes, catholyte and anolyte inlet solutions were DIW after sitting in the lab; initial conductivity=0.742 μS/cm. KNO₃ removal was ˜94% complete. The majority of the power is consumed at the inlet by the anion exchange membrane and anolyte solution; near the exit as the catholyte and anolyte solutions approach DIW they become the dominant power consumers.

FIG. 17 shows simulated power distribution (left ordinate) and KNO₃ removal (right ordinate) along the length of an 8 cm device at equipotential. Conditions are the same as FIG. 16 except 10 mM of HNO₃ and KOH are respectively used as initial regenerant solutions for the catholyte and anolyte respectively. Seeding the channels with a conductive regenerant greatly enhances the KNO₃ removal. At the inlet, the membranes consume the most power but as the eluent concentration drops, the power is shifted to the eluent which becomes depleted leading to a break in current and no further power draw.

FIG. 18 shows screening of stepped voltages across the 4 electrodes. Conditions are the same as in FIG. 17. Equipotential voltages are shown as the solid line and stepped voltages with power distribution % RSD≤20% are shown as the dashed line. Regardless of the voltage profile used, the total power for a desired % removal is quite consistent. Equipotential and power matched step profiles provide the most efficient removal with the power matched settings being marginally better at the highest removal efficiencies. Each subsequent electrode from E1-E4 increased by up to 1-2 times the preceding electrode in steps of 0.25. E1 was tested from 2-4 Volts so that E4 maximally reached 32 Volts (2³*4). An example set of voltages (E1/E2/E3/E4) would then be: 2/2/2/2, 2/2/2/2.5, 2/2/2/3, 2/2/2/3.5, 2/2/2/4, 2/2/2.5/2.5, 2/2/2.5/3.125 Apr. 8, 2016/16, Apr. 8, 2016/20, Apr. 8, 2016/24, Apr. 8, 2016/28, Apr. 8, 2016/32.

FIG. 19 shows simulated power distribution of an optimal stepped electrode configuration. Voltages were determined from the stepped voltage simulation in FIG. 18 that produced 99% KNO₃ removal with a power distribution≤20%. The potential and power at each electrode are provided in the figure. All other conditions are the same as in FIG. 17. In the first 2 electrodes, the AEX is still the largest consumer of energy but dips below the eluent in E3. The final stage contains the greatest power consumption but this is predominantly focused in the eluent. This is preferred to the equipotential arrangement where energy is consumed near the inlet as the regenerant solution entering near the effluent outlet is cool and/or most of the heat will be removed out of the device by the effluent instead of heating the membranes. Note the difference in scale between FIGS. 19 and 16; peak power consumption in any membrane or channel is decreased by a factor of 6-7. Interestingly, removal of KNO₃ along the device despite the varying voltages proceeds in an almost linear fashion until the final electrode.

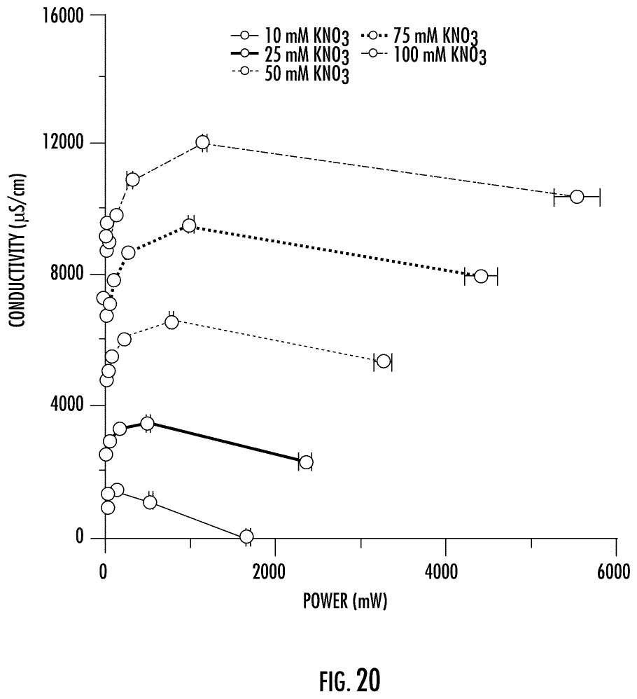

DMs were then inserted into the EDDs and electrical behavior characterized as above. Two DMs were used on each side. Initial tests showed no difference in conductance between 1 or 2 membranes but delaminating and handling a single membrane was more difficult. The addition of the DMs substantially increases the energy demands for both IEM configurations (FIG. 4). For the CEM/AEM, addition of DMs results in a pseudo-bipolar membrane (BPM) at the AEM side. Regenerated cellulose has a negative zeta potential and thus will act like a weak CEM. BPMs promote water splitting at the interface between the two IEMs; H at the DM displaces the eluent cations while the negative surface charge limits anion flux to the AEM converting KNO₃ and AmOAc into their respective acids. A perfect BPM is not formed permitting some anion transfer (see FIG. 20) but this process is inefficient. Graft polymerization of VS or DMAEMA was carried out to produce more negatively or positively/neutrally charged DMs, and used adjacent the CEMs and AEMs respectively. VS-DMs provided no benefit over unfunctionalized DMs in the CEM/CEM (FIG. 4); membrane resistance is not limiting. The BPM effect was eliminated using functionalized DMs for the CEM/AEM device, and complete desalting could be attained.

Referring briefly to FIG. 20, power required for desalting various concentrations of KNO₃ on a CEM/AEM+DM device is illustrated. DMs are unfunctionalized and thus have a negative surface charge. This causes the AEM side to act as a pseudo bipolar membrane resulting in first, formation of HNO₃ leading to a rise in conductance followed by gradual, inefficient and incomplete removal of NO₃″ except at the lowest concentration of 10 mM. Electrodes are equipotential; conditions are the same as FIG. 2.

Based on the curves' inflection points, desalting energy increased by 340±30 mW and 570±40 mW for the CEM/CEM and CEM/AEM, respectively upon addition of the DMs, a 97±8% and 52±4% increase, respectively. For the CEM/CEM, chemical exchange of NH₄ accounts for >40% reduction in initial conductance; ˜210 mW is required to attain similar levels for the DM device. Correcting for chemical exchange, the DMs increase power only 23%. VS modified DMs had no effect.

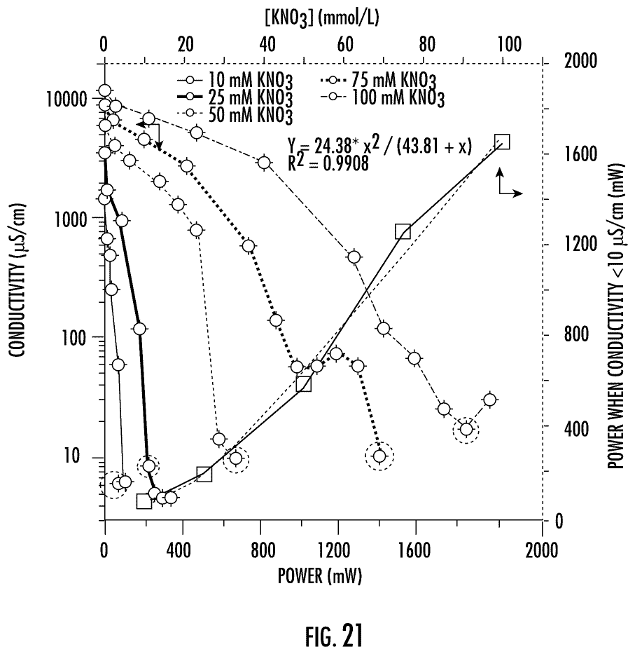

The three salts, at 10-100 mM concentrations were again tested on the CEM/AEM while the 2 OAc⁻ salts were measured on the CEM/CEM containing functionalized DMs (FIGS. 21-25). As before, desalting was considered complete when the conductivity was <10 μS/cm on the CEM/AEM and at the minimum on CEM/CEM. Sufficient desalting was attained for all with the exception of NaOAc on the CEM/AEM device which formed HOAc. Regardless of device or salt, the desalting energy was no longer linear with concentration. For NaOAc on the CEM/CEM, power usage was 1% higher on the DM containing device for 10 mM but was 63% greater at 100 mM. For the CEM/AEM (FIGS. 21-23) initial power requirements were actually lower with 67% less energy needed for 10 mM KNO₃ on the DM device but were 5% higher at 100 mM.

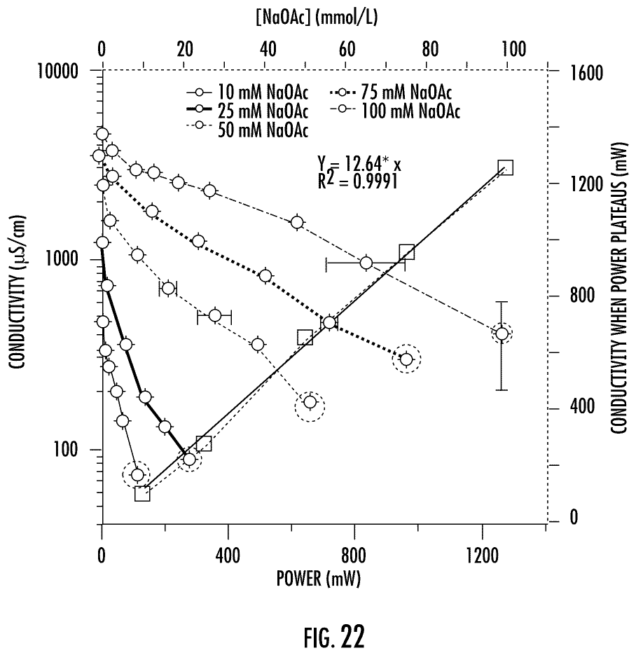

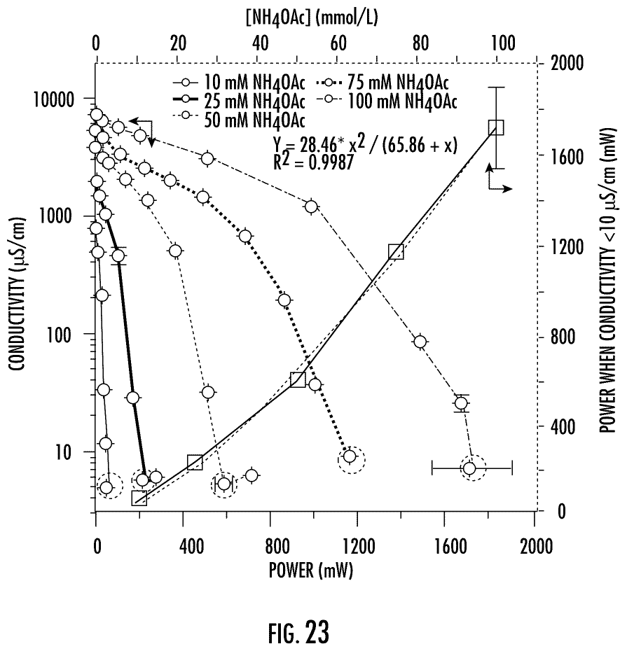

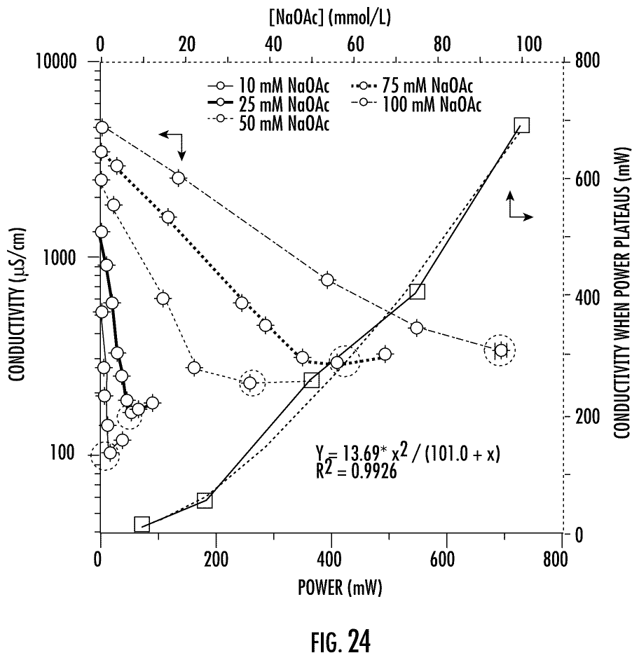

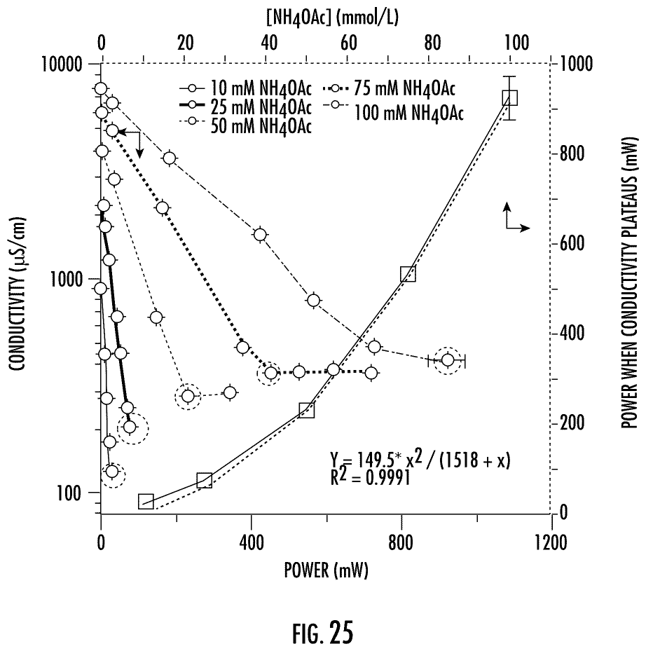

Referring briefly to the FIGS., FIG. 21 illustrates power required for desalting of various concentrations of KNO₃ on an CEM/AEM+DM device. DMs are functionalized. Compared to FIG. 20, functionalized DMs allow for near complete salt removal. Electrodes are equipotential; conditions are the same as FIG. 2. The power for desalting was initially nonlinear and was best predicted by the fit shown which approaches linearity at higher concentrations. Relative to the device without DMs, the power required for desalting was 67% lower at 10 mM and increased to be 5% higher at 100 mM. FIG. 22 illustrates power required for desalting of various concentrations of NaOAc on a CEM/AEM+DM device. Functionalized DMs are used. The power vs the solution conductance uses the lower abscissa and left ordinate, respectively for the various solution concentrations. Either due to the bipolar membrane effect or water splitting in the central channel followed by removal of Na, HOAc is being formed. No plateau was observed before the maximum voltage was reached or system pressure began to rise so the lowest conductance was used to estimate power draw. The lowest conductance is similar to that observed for the CEM/CEM confirming that HOAc is being formed. This power is plotted vs the concentration: right ordinate and top abscissa respectively. Required power for desalting appears to remain linear in this case even if it is incomplete. Relative to the device without DMs (FIG. 11), the slope of the linear fit is % 26 lower. Though removal is not complete, it appears functionalization of the membranes has still resulted in tangible power savings for NaOAc. Electrodes were operated at equipotential. Conditions are the same as FIG. 2. FIG. 23 illustrates power required for desalting of various concentrations of NH₄OAc on a CEM/AEM+DM device. DMs were functionalized. The power vs the solution conductance uses the lower abscissa and left ordinate, respectively for the various solution concentrations. Desalting is near complete and formation of HOAc due to bipolar membrane effects is minimal if present at all. Where conductance reaches a minimum for each concentration is circled. This power is plotted vs the concentration: right ordinate and top abscissa respectively. Required power for desalting appears initially to increase exponentially with the effluent concentration before becoming linear. Relative to the device without DMs (FIG. 12), the necessary power for desalting is only 20% at 10 mM and increases to 26% at 25 mM; 65% at 50 mM, 76% at 75 mM and 121% at 100 mM. The lower power required for 10 mM may also be due to the initial starting conductance being approximately 60% that observed previously; likely due to chemical ion exchange of NH₄⁺. Electrodes were operated at equipotential. Conditions are the same as FIG. 2. FIG. 24 illustrates power required for desalting of various concentrations of NaOAc on a CEM/CEM+DM device. The power vs the solution conductance uses the lower abscissa and left ordinate, respectively for the various solution concentrations. Only the Na is removed to form HOAc; the first point at or after the plateau vertex was used and is circled. This power is plotted vs the concentration: right ordinate and top abscissa respectively; the relationship is nonlinear at low concentrations before becoming relatively linear. The curve is well described by the fit which becomes linear at high concentrations. Relative to the device without DMs, the power required for desalting is only 1.2% higher at 10 mM and increases to 163% at 100 mM. At 25 mM, power usage was only 21±8% higher than the device without DMs. Electrodes were operated at equipotential. Conditions are the same as FIG. 2. FIG. 25 illustrates power required for desalting of various concentrations of AmOAc on a CEM/CEM+DM device. The power vs the solution conductance uses the lower abscissa and left ordinate, respectively for the various solution concentrations. Only the NH₄⁺ is removed to form HOAc; the first point at or after the plateau vertex was used and is circled. This power is plotted vs the concentration: right ordinate and top abscissa respectively; the relationship is nonlinear at low concentrations before becoming relatively linear. The curve is well described by the fit which becomes linear at high concentrations. Relative to the device without DMs, the power required for desalting is 41% higher at 10 mM and increases to 400% higher at 100 mM. At 25 mM power usage was only 21% higher than the device without DMs. Electrodes were operated at equipotential. Conditions are the same as FIG. 2. Despite the higher mobility of NH₄⁺, power requirements were on average 30% greater for AmOAc than NaOAc.

Without ionic functionalities and high solution permeability, DM conductance should be proportional to that of the effluent channel. It is surprising then that the DMs which have a combined nominal thickness of 120 μm or 24% of the space between the CEMs, should cause large increases in required energy while others have shown thicker UF membranes with similar MWCO to be as conductive as IEMs. That grafting VS to the DM also showed no improvement suggests membrane resistance alone is not responsible for the increase power demand.

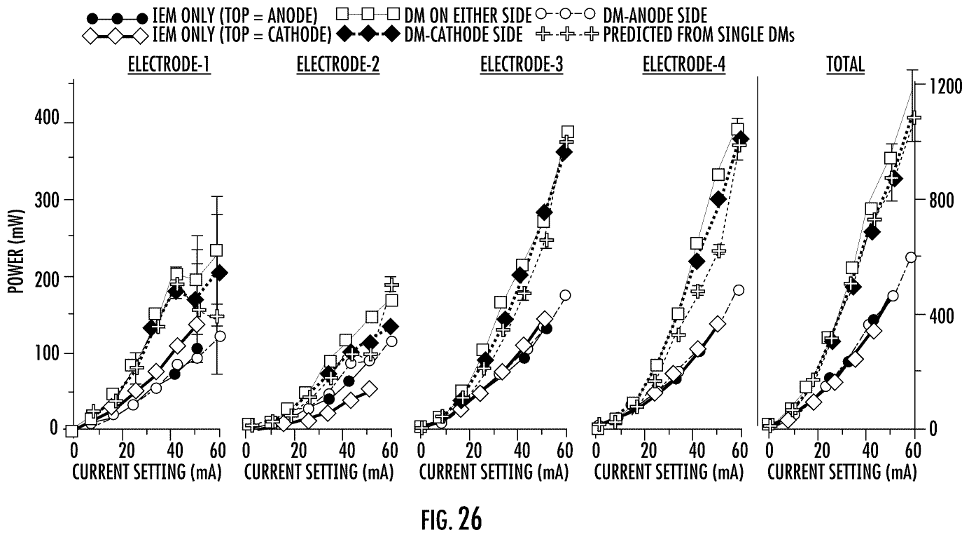

To ascertain the cause of the unexpectedly high power demand, the functionalized or unfunctionalized DMs were placed on a single side of the CEM/CEM channel. Conductance-power curves were generated before switching the electrode polarity and measuring again to determine whether there was a difference between the cathode or anode side. Results were then compared using DMs on both sides of the effluent channel. AmOAc and AmF were both used to investigate whether the acid strength affects the DM conductance. Results are broken down by electrode and provided in FIGS. 26-29.

Turning briefly to these figures, FIG. 26 illustrates the effect of adding vinylsulfonic acid functionalized DMs to a CEM/CEM device. The effluent is 100 mM AmF flowing at 0.25 mL/min. 200 mM HNO₃ is flowing through the outer channels at 0.75 mL/min as regenerant. The DM is placed on the effluent inlet/outlet side of the channel (device top) and the electrode polarity reversed to determined whether asymmetric effects occur. The results are compared with a device with IEMs switching polarities as well as a device with DMs on both sides of the effluent channel. The predicted power from single DMs is computed by adding DM-Anode and DM-Cathode and Subtracting IEM-Cathode to compensate for any polarity differences in the system. Constant current operation was used for comparison in the next 4 figures. For devices at or near Faradaic efficiency, the total ion transport will be approximately equal for a given current and thus power computed will be reflective of that needed for desalting. Since all electrodes are at the same potential, changes in power reflect the relative distribution in current. IEM polarity had some minor effect on Electrodes 1 and 2. The DM at the cathode side was entirely responsible for the increase in power usage. As desalting neared completion, current at electrodes 3 and 4 began to increase more rapidly than 1 or 2. This imbalance wasn't observed when just using IEMs. Behavior was found to be ohmic; power increases with the square of the current: P=I²R.

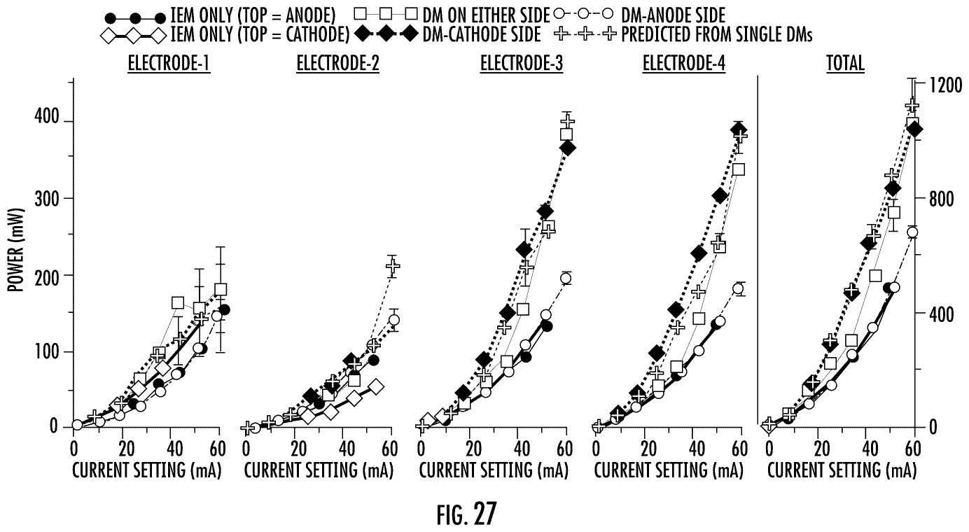

FIG. 27 illustrates the effect of adding vinylsulfonic acid functionalized DMs to a CEM/CEM device. Conditions are the same as FIG. 26 except the effluent is 100 mM AmOAc. Results are identical to using AmF above with current increasing in the latter electrodes. The cathode side DM results in the increase in power, and total power consumed is similar to AmF.

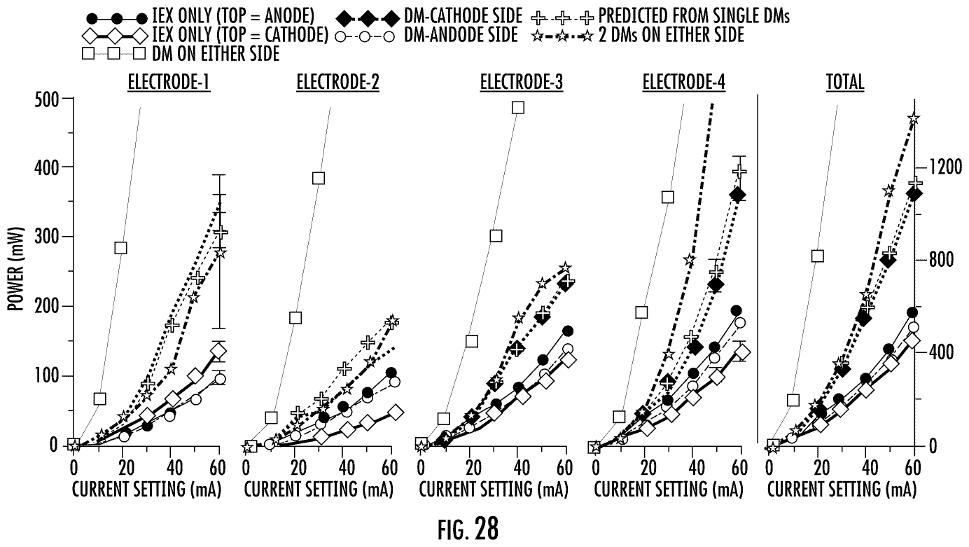

FIG. 28 illustrates the effect of adding DMs to a CEM/CEM device. Conditions are the same as FIG. 26 except DMs are unfunctionalized. Effluent is 100 mM AmF. Use of single membranes on either side resulted in very high power usage, possibly due to misalignment or membrane wrinkling. Use of 2 DMs which are structurally more sound agree with the predicted results from single DMs. Current increases in electrode 4 though for 2 DMs faster than the other 3 electrodes. Nevertheless, that 2 DMs agree well with the predicted single DMs suggest DM resistance is not limiting.

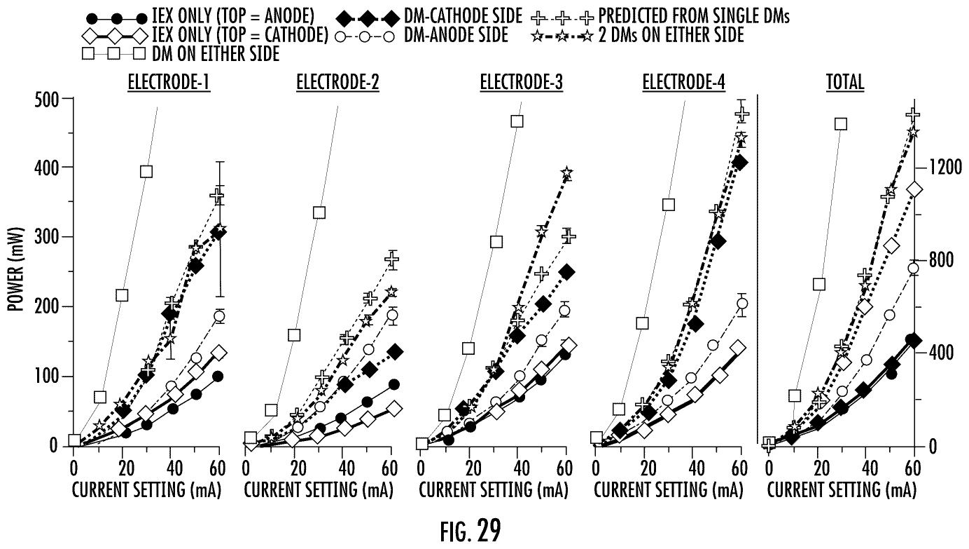

FIG. 29 illustrates the effect of adding DMs to a CEM/CEM device. Conditions are the same as FIG. 28 except effluent is 100 mM AmOAc. Note that anode DM power draw is greater than AmF due to the lower dissociation constant of acetic acid relative to formic acid. Use of single membranes on either side resulted in very high power usage, possibly due to misalignment or membrane wrinkling. Use of 2 DMs which are structurally more sound agree with the predicted results from single DMs. Nevertheless, that 2 DMs agree well with the predicted single DMs suggest DM resistance is not limiting

Below 50 mA, the devices obeyed Ohm's law and the slope of the current-voltage curves (R²>0.993) was used to compute the resistance. Without DMs, the total resistance was 86-89Ω and 85-88Ω for AmOAc and AmF, respectively. Addition of the unfunctionalized DMs to the anode side, increased resistance by 88Ω and 9Ω for AmOAc and AmF, respectively and is in keeping with the 10× difference in acid dissociation constant for acetic (pKₐ=4.76) and formic acids (pKₐ=3.75). VS grafted DMs were more conductive adding <1.3Ω to total resistance at the anode irrespective of the salt. Reversing the polarity, the unfunctionalized DM resistance increased to 211Ω and 192Ω for AmOAc and AmF, respectively; the VS-DM was marginally better at 154Ω and 183 22, respectively.

The DMs are not bonded to the IEMs forming an interstitial layer of water between them. It is likely that Electroosmotic flow (EOF) of water bound to the cations may be responsible for the increased power demand. EOF proceeds towards the cathode which passes through the DM but is impeded at the CEM due to the smaller pore structure. Water accumulation between the layers occurs resulting in the DM encroaching into the effluent flow channel. Pressure increases under high loads have been observed that may be explained by membrane distension; this pressure effect is especially pronounced for Na which has a greater hydrated radius than NH₄⁺ or K⁺.³⁸ Both due to the electrode polarity and negative surface charge of the DM, the interstitial layer at the cathode side may be depleted of anions; under such a condition, additional water splitting would be required for cation transport through this space further increasing the power demand. At the anode side, water would be stripped from the interface by the electromigration of H keeping the DM in contact with the CEM while the polarity would keep the DM and interstitial water layer saturated with the effluent anion. Using single layers of unfunctionalized DMs on both sides, results in higher than predicted power draw possibly due to membrane contact, but two layers agree with values predicted from the single DM measurements further supporting that phenomena at cathode interface rather than DM resistance is the cause. Eliminating the interstitial layer using a hybrid IEM membrane with low-binding ion permeable skin may be possible.

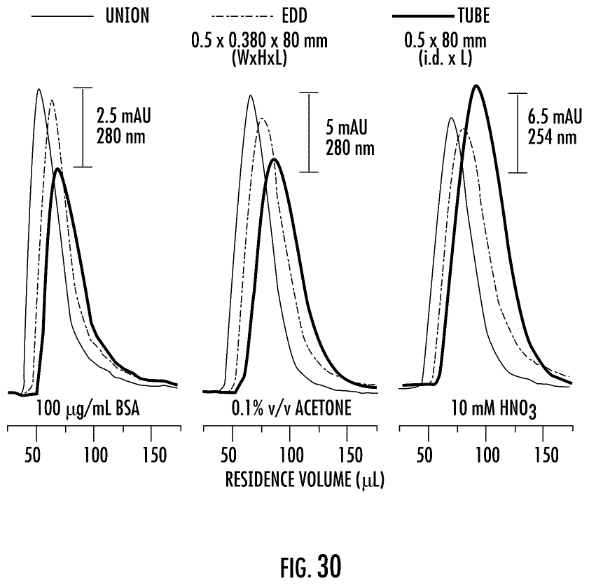

Dispersion and Recovery. EDD dispersion was measured with 3 analytes injected through the EDD and a zero dead volume union in its stead. HNO₃ and acetone are charged and neutral small molecules, respectively that may probe the DM pores and differentiate electric field effects. BSA was chosen due to its high molecular weight (66.5 kDa) such that it is entirely excluded from the DMs with MWCO 6-8 kDa. Comparisons were also made using a 0.5 mm i.d. PEEK tube of equivalent length to the EDD flow channel; the 0.5 mm i.d. was chosen as an approximation of the EDD nominal cross-sectional dimensions: 0.5×0.38 mm. Nominal volumes were close at 15.7 and 15.2 μL for the tube and EDD respectively. The measured tube volume based on elution time of acetone/HNO₃ was 16-24 μL across the flow rate range (0.1-1.0 mL); somewhat higher than calculated. The EDD volume measured 8.6-15 μL; lower than expected possibly due to compression of the gasket. BSA was observed to be narrower (FIG. 30, example FIAgrams) but less symmetric and the maxima arrived at the detector earlier than HNO₃ or Acetone. The magnitude of this difference was flow rate dependent; acetone arrived 17 μL after BSA at 0.1 mL/min but this decreased to 4 μL at 1 mL/min using the union. FIG. 30 illustrates FIAgrams of BSA, Acetone, and HNO₃ analytes injected (5 μL) in DIW carrier flow at 0.25 mL/min through either a union, a tube, or EDD. In flow injection analysis (FIA) the residence time is defined as the minimum time interval between introduction of a specimen and the production of the corresponding result(s), and is conceptually similar to the elution time in liquid chromatography (LC); however, no corresponding volumetric term has been accepted for FIA that is equivalent to elution volume in LC. Herein is defined a residence volume which is the product of the residence time measured since injection and the solution flow rate.

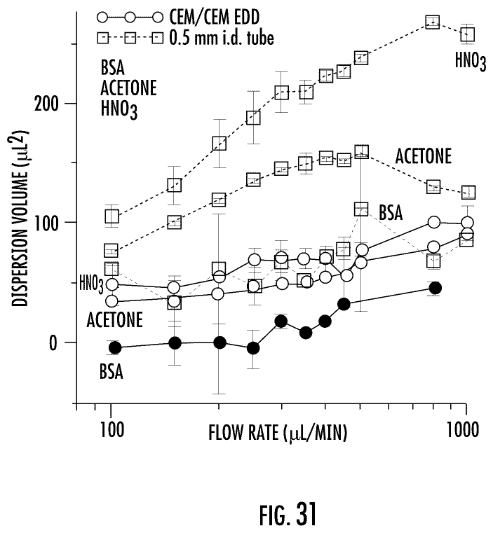

Dispersion volumes, in μL², were measured as the difference in peak variance between the union and tube or EDD; the variance being calculated from the peak width at half height (W_{0.5}) assuming a gaussian peak: σ²=W_{0.5}²/[8*ln(2)]. Dispersion was consistently better for the EDD than the tube at all flow rates and analytes (FIG. 31) for W_{0.5}. Median dispersion values were 145-194% higher than those obtained on the EDD. At low flows, BSA dispersion was relatively flat and for the EDD was statistically indistinguishable from the union despite the 2 right angle connections into and out of the EDD. At higher flow rates, BSA dispersion began to align with HNO₃ and Acetone though all were below 100 μL². At low flow rates, the increased residence time may lead to greater sorption to the DMs, though this was not observed for BSA due to the low protein binding of the regenerated cellulose membranes used. The EDD dispersion volume was reasonably linear with flow rate and had slopes 0.06±0.02, 0.063±0.007, 0.10±0.04 μL*min for HNO₃, Acetone, and BSA respectively (error is 95% confidence; r² ranged from 0.7976 to 0.9798).

As illustrated in FIG. 31, dispersion volumes of the EDD and comparably sized PEEK tube from 0.1-1.0 mL/min are shown. Volumes were computed from the peak width at half height and converting to variance based on a Gaussian peak. The dispersion in chromatographic tubing has been studied both experimentally and theoretically over a range of tubing dimensions, diffusion coefficients, and flow rates. It was shown that for reduced velocities ≤12,500, volumetric dispersion follows the Aris-Taylor mode:

$${σ}^{2} = \frac{π {r}^{4} L F}{24 D} \qquad Eq ( 1 )$$

Where r and L are respectively tubing bore radius and length, F is the flow rate, and D is the diffusion coefficient of the analyte. The reduced velocity is simply 2Fπ⁻¹D⁻¹r⁻¹; for NO₃⁻ (D≈1.9*10⁻⁵ cm²/s), the dispersion in a 0.5 mm i.d. tube is expected to be linear with flow rate even up to 0.56 mL/min, though observed deviation started to occur at >300 μL/min, possibly due to the pressure shock in the system. Acetone dispersion was similarly linear only up to ˜250 μL/min for the tube. Dispersion for both was linear however with flow rate up to 1000 μL/min for the EDD. From equation 1 it can be seen that the ratio of the slopes (m=σ2/F) will simply yield the ratio of the radii to the 4^{th} power (m_{tube}/m_{EDD}=r_{tube}⁴/r_{EDD}⁴), from which the effective diameter of the EDD may be determined. For HNO₃ and Acetone, this was respectively determined to be 0.29 and 0.32 mm; BSA dispersion in the tube was too small to be quantified accurately. This effective radius is in keeping with the thickness of the gasket suggesting future devices may tolerate wider channels to improve maximum salt load without significantly increasing dispersion.

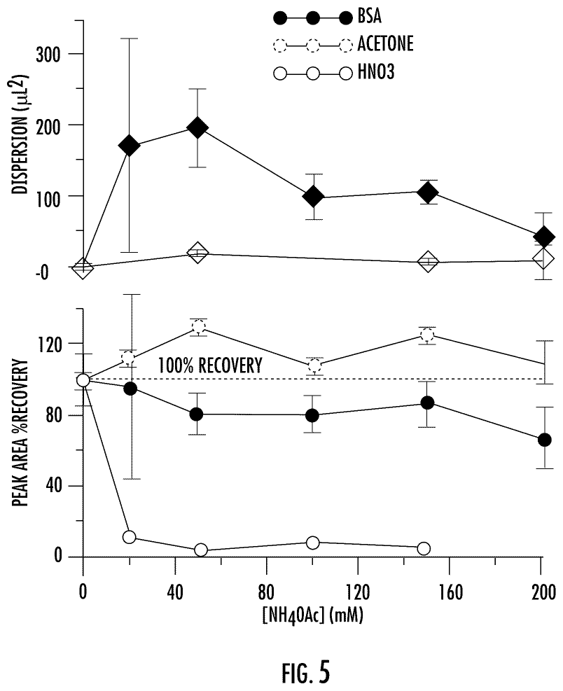

The peaks were not Gaussian and the second statistical moment (SM) should provide a better basis for measuring dispersion. However, the calculation reproducibility between runs was lower than W_{0.5}. Values for the tube were generally in good agreement at 80±10% and 110±40% that of W_{0.5} for HNO₃ and Acetone respectively. For the EDD however, the respective dispersion volumes computed by SM were on average 240±60% and 220±50% that computed by W_{0.5} and within 20% of the SM values obtained for the tube. The SM values for BSA were not reproducible; assuming a correction factor of 2.5, dispersion should not exceed 250 μL². As Illustrated in FIG. 5, Dispersion (top) and Recovery (bottom) of BSA, Acetone, and HNO₃ at the various AmOAc concentrations and optimal power for desalting. Flow rate=0.25 mL/min.

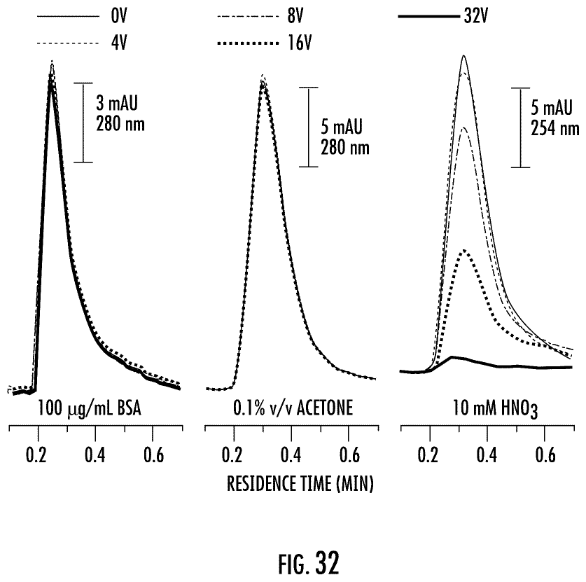

Applying a voltage up to 32 V using DIW as carrier had no effect on BSA or acetone but HNO₃ was retained or lost in the device (FIG. 32). Assuming the entire voltage drop is across the 0.38 mm thick channel, the field strength is ˜84 kV/m, higher than most capillary electrophoresis applications and clearly capable of causing anion retention in the device. That no broadening or loss of BSA (pI-4.9) which is similarly negative charged suggests the DMs are acting as intended and restricting access to the internal pores.

Referring briefly to FIG. 32, FIAgrams of BSA, Acetone, and HNO₃ in DIW flowing at 0.25 mL/min are illustrated. Device voltage is increased. No effects are observed for BSA or acetone while HNO₃ becomes almost entirely retained or lost in the device.

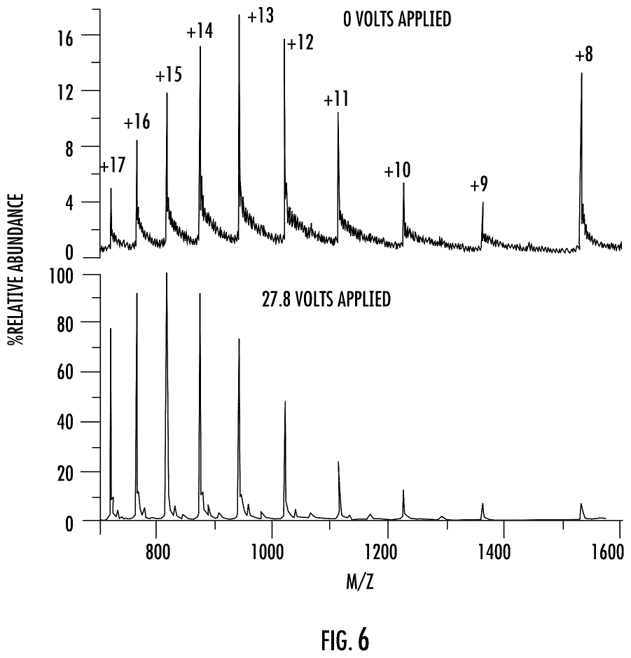

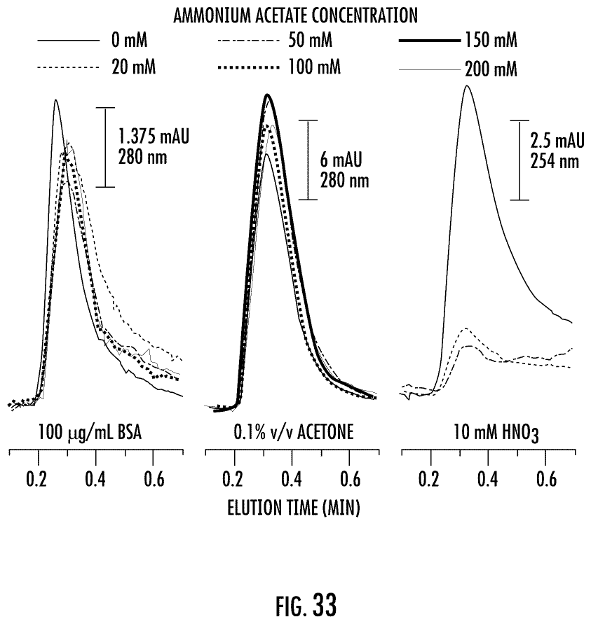

The salt load was increased up to 200 mM AmOAc and the EDD voltage adjusted to achieve desalting; dispersion and recovery are shown in FIG. 5. Acetone recoveries showed no dependence upon AmOAc concentration though values were high relative to DIW (117±9%); evaporative loss from the older DIW standard relative to the freshly prepared AmOAc solutions is likely. Further, no discernible broadening was observed (FIG. 33). HNO₃ as discussed above was either lost to or retained in the EDD. The present arrangement is similar to that originally conceived in electrical field-flow fractionation (EFFF). However, only minor retention/tailing of BSA occurred at low concentrations of AmOAc likely due to a combination of the much higher than optimal flow for EFFF, absence of relaxation time, as well as disruption of laminar flow at the membrane surface caused by the woven PEEK mesh. The desalted AmOAc pH will vary from ˜3.1-2.6 assuming complete conversion to HOAc (pKa=4.74); BSA will be positively charged. Increasing the AmOAc concentration reduces the pH increasing the charge on BSA; the necessary field strength is also increased to attain complete desalting. Both effects would lead to increased retention either through electrostatic interactions with the negatively charged DMs or retention by EFFF if either is a major contributor. BSA recoveries ranged from 67-96% albeit standard deviations are large (>10% RSD) due to the low absorbance. Loss of a lower mass but more intensely absorbing impurity or spectral shifts due to a pH change could reduce apparent recovery. FIG. 6 illustrates Mass spectrograms of Cytochrome C (chicken) infusion in 50 mM AmOAc and 0.1% FA through the EDD with and without applied potential. Signal is relative to the EDD at 27.8 volts. Referring to FIG. 33, FIAgrams of BSA, Acetone, and HNO₃ in 0-200 mM AmOAc flowing at 0.25 mL/min and desalted using minimum power required is illustrated. At 0 mM, a static potential of 18 V is applied. Samples were dissolved in the carrier prior to injection. Peak shape for acetone was consistent while BSA showed moderate retention and tailing. HNO₃ as seen in FIG. 30 is retained in the EDD.

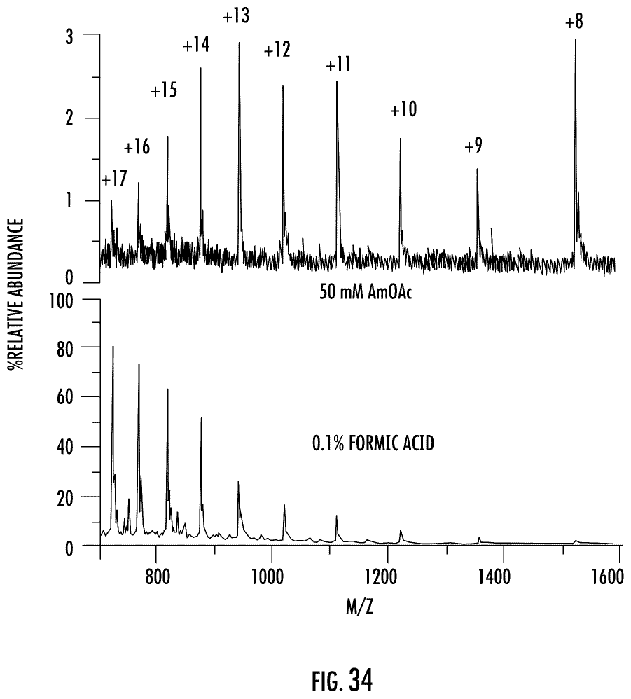

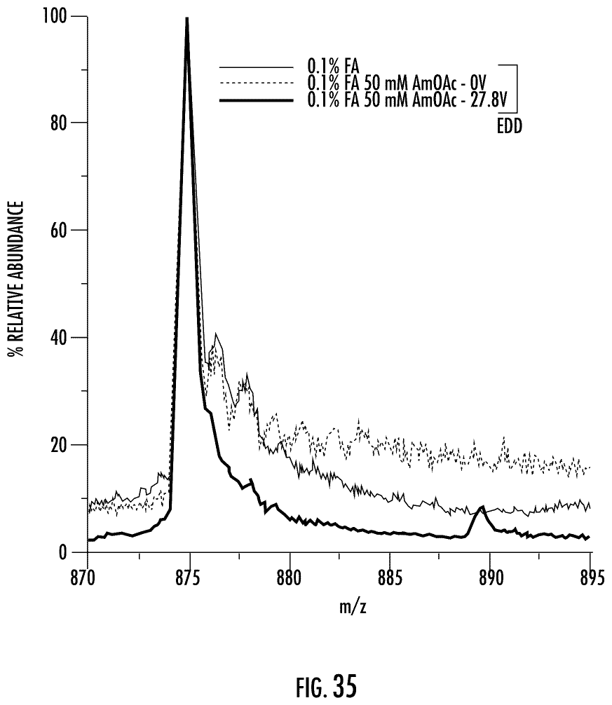

Mass Spectrometry. The impact of high salt concentration on the MS signal intensity is clearly seen in FIG. 6. At 0 volts, the maximum signal intensity observed during infusion of cytochrome c (in 50 mM AmOAc and 0.1% FA) is only 16% that at 27.8 volts and was <3% when 50 mM AmOAc was used without the EDD present (FIG. 34). Adduct formation was also prevalent as evidenced by the tailing to higher masses (FIG. 35). As the EDD voltage is increased to 27.8 volts, peak shape improves; additionally, the reduction in pH leads to higher charge states (lower m/z). Smaller impurity peaks that were obscured are now also readily seen in the mass spectrogram. Cytochrome C at ˜12 kDa is closer to the MWCO of the DMs (6-8 kDa) than BSA and more basic (p/=9.28); despite this there is no evidence that significant loss is occurring.

Referring to FIG. 34, mass spectrograms of Cytochrome C (chicken) dissolved in 50 mM AmOAc or 0.1% FA infused directly into the MS is illustrated. Signals are relative to the lower trace in FIG. 6 using the EDD with 27.8 Volts applied. FIG. 35 illustrates narrow mass spectrogram of +14 charge of cytochrome-C. The EDD at 27.8 volts applied clearly shows fewer adducts for 50 mM AmOAc with 0.1% FA relative to 0 V applied or even 0.1% FA alone. A trace constituent is also visible at a higher m/z that is obscured by the adducts.

According to the experimental section provided herein, as can be seen an electrodialytic desalter has been demonstrated for removal of salts prior to ESI-MS. Combination of ion exchange and size selective (dialysis) membranes allows for removal of small salts while retaining large, charged polymers such as proteins. The small volume/low dispersion characteristics make the EDD compatible for analysis of limited sample quantities or temporally sensitive sample streams such as used in LC. The low residence time could also increase sample throughput while achieving greater desalting than extant online methods.

### REFERENCES

Enke, C. G. A Predictive Model for Matrix and Analyte Effects in Electrospray Ionization of Singly-Charged Ionic Analytes. Anal. Chem. 1997, 69 (23), 4885-4893. https://doi.org/10.1021/ac970095w.
Furey, A.; Moriarty, M.; Bane, V.; Kinsella, B.; Lehane, M. Ion Suppression; A Critical Review on Causes, Evaluation, Prevention and Applications. Talanta 2013, 115, 104-122. https://doi.org/10.1016/j.talanta.2013.03.048.
Wang, G.; Cole, R. B. Effect of Solution Ionic Strength on Analyte Charge State Distributions in Positive and Negative Ion Electrospray Mass Spectrometry. Anal. Chem. 1994, 66 (21), 3702-3708. https://doi.org/10.1021/ac00093a026.
Annesley, T. M. Ion Suppression in Mass Spectrometry. Clin. Chem. 2003, 49 (7), 1041-1044. https://doi.org/10.1373/49.7.1041.
Tang, K.; Page, J. S.; Smith, R. D. Charge Competition and the Linear Dynamic Range of Detection in Electrospray Ionization Mass Spectrometry. J. Am. Soc. Mass Spectrom. 2004, 15 (10), 1416-1423. https://doi.org/10.1016/j.jasms.2004.04.034.
Metwally, H.; McAllister, R. G.; Konermann, L. Exploring the Mechanism of Salt-Induced Signal Suppression in Protein Electrospray Mass Spectrometry Using Experiments and Molecular Dynamics Simulations. Anal. Chem. 2015, 87 (4), 2434-2442. https://doi.org/10.1021/ac5044016.
Naegele, E. Making Your LC Method Compatible with Mass Spectrometry Technical Overview
Leblanc, Y.; Ramon, C.; Bihoreau, N.; Chevreux, G. Charge Variants Characterization of a Monoclonal Antibody by Ion Exchange Chromatography Coupled On-Line to Native Mass Spectrometry: Case Study after a Long-Term Storage at +5° C. J. Chromatogr. B Anal. Technol. Biomed. Life Sci. 2017, 1048, 130-139. https://doi.org/10.1016/j.jchromb.2017.02.017.
Hedges, J. B.; Vahidi, S.; Yue, X. F.; Konermann, L. Effects of Ammonium Bicarbonate on the Electrospray Mass Spectra of Proteins: Evidence for Bubble-Induced Unfolding. Anal. Chem. 2013, 85 (13), 6469-6476. https://doi.org/10.1021/ac401020s.
Chen, B.; Lin, Z.; Alpert, A. J.; Fu, C.; Zhang, Q.; Pritts, W. A.; Ge, Y. Online Hydrophobic Interaction Chromatography-Mass Spectrometry for the Analysis of Intact Monoclonal Antibodies. Anal. Chem. 2018, 90 (12), 7135-7138. https://doi.org/10.1021/acs.analchem.8b01865.
Sandra, K.; Vandenheede, I.; Sandra, P. Modern Chromatographic and Mass Spectrometric Techniques for Protein Biopharmaceutical Characterization. J. Chromatogr. A 2014, 1335, 81-103. https://doi.org/10.1016/j.chroma.2013.11.057.
Clarke, D. J.; Campopiano, D. J. Desalting Large Protein Complexes during Native Electrospray Mass Spectrometry by Addition of Amino Acids to the Working Solution. Analyst 2015, 140 (8), 2679-2686. https://doi.org/10.1039/c4an02334j.
Demuth, J. C.; McLuckey, S. A. Electrospray Droplet Exposure to Organic Vapors: Metal Ion Removal from Proteins and Protein Complexes. Anal. Chem. 2015, 87 (2), 1210-1218. https://doi.org/10.1021/ac503865v.
Weng, G.; Liu, Z.; Chen, J.; Wang, F.; Pan, Y.; Zhang, Y. Enhancing the Mass Spectrometry Sensitivity for Oligonucleotide Detection by Organic Vapor Assisted Electrospray. Anal. Chem. 2017, 89 (19), 10256-10263. https://doi.org/10.1021/acs.analchem.7b01695.
Yuill, E. M.; Sa, N.; Ray, S. J.; Hieftje, G. M.; Baker, L. A. Electrospray Ionization from Nanopipette Emitters with Tip Diameters of Less than 100 Nm. Anal. Chem. 2013, 85 (18), 8498-8502. https://doi.org/10.1021/ac402214g.
Wei, Z.; Han, S.; Gong, X.; Zhao, Y.; Yang, C.; Zhang, S.; Zhang, X. Rapid Removal of Matrices from Small-Volume Samples by Step-Voltage Nanoelectrospray. Angew. Chemie—Int. Ed. 2013, 52 (42), 11025-11028. https://doi.org/10.1002/anie.201302870.
Gong, X.; Xiong, X.; Zhao, Y.; Ye, S.; Fang, X. Boosting the Signal Intensity of Nanoelectrospray Ionization by Using a Polarity-Reversing High-Voltage Strategy. Anal. Chem. 2017, 89 (13), 7009-7016. https://doi.org/10.1021/acs.analchem.7b00555.

Zhang, Z.; Pulliam, C. J.; Flick, T.; Cooks, R. G. Electrophoretic Desalting to Improve Performance in Electrospray Ionization Mass Spectrometry. Anal. Chem. 2018, 90 (6), 3856-3862. https://doi.org/10.1021/acs.analchem.7b04529.
Fountain, K. J.; Gilar, M.; Gebler, J. C. Analysis of Native and Chemically Modified Oligonucleotides by Tandem Ion-Pair Reversed-Phase High-Performance Liquid Chromatography/Electrospray Ionization Mass Spectrometry. Rapid Commun. Mass Spectrom. 2003, 17 (7), 646-653. https://doi.org/10.1002/rcm.959.
Gilar, M.; Belenky, A.; Wang, B. H. High-Throughput Biopolymer Desalting by Solid-Phase Extraction Prior to Mass Spectrometric Analysis. In Journal of Chromatography A; Elsevier, 2001; Vol. 921, pp 3-13. https://doi.org/10.1016/S0021-9673 (01) 00833-0.
Opiteck, G. J.; Lewis, K. C.; Jorgenson, J. W.; Anderegg, R. J. Comprehensive On-Line LC/LC/MS of Proteins. Anal. Chem. 1997, 69 (8), 1518-1524. https://doi.org/10.1021/ac9611551.
Sharma, S.; Simpson, D. C.; Tolić, N.; Jaitly, N.; Mayampurath, A. M.; Smith, R. D.; Paša-Tolić, L. Proteomic Profiling of Intact Proteins Using WAX-RPLC 2-D Separations and FTICR Mass Spectrometry. J. Proteome Res. 2007, 6 (2), 602-610. https://doi.org/10.1021/pr060354a.
Farsang, E.; Guillarme, D.; Veuthey, J. L.; Beck, A.; Lauber, M.; Schmudlach, A.; Fekete, S. Coupling Non-Denaturing Chromatography to Mass Spectrometry for the Characterization of Monoclonal Antibodies and Related Products. Journal of Pharmaceutical and Biomedical Analysis. Elsevier B. V. Jun. 5, 2020, p 113207. https://doi.org/10.1016/j.jpba.2020.113207.
Jakubowski, J. A.; Hatcher, N. G.; Sweedler, J. V. Online Microdialysis-Dynamic Nanoelectrospray Ionization-Mass Spectrometry for Monitoring Neuropeptide Secretion. J. Mass Spectrom. 2005, 40 (7), 924-931. https://doi.org/10.1002/jms.869.
Wu, Q. Y.; Liu, C. L.; Smith, R. D. On-Line Microdialysis Desalting for Electrospray Ionization Mass Spectrometry of Proteins and Peptides. Rapid Commun. Mass Spectrom. 1996, 10 (7), 835-838. https://doi.org/10.1002/(sici) 1097-0231 (199605) 10: 7<835::aid-rcm573>3.0.co; 2-5.
Wu, W.; Zhang, D.; Chen, K.; Zhou, P.; Zhao, M.; Qiao, L.; Su, B. Highly Efficient Desalting by Silica Isoporous Membrane-Based Microfluidic Chip for Electrospray Ionization Mass Spectrometry. Anal. Chem. 2018, 90 (24), 14395-14401. https://doi.org/10.1021/acs.analchem.8b03934.
Wilson, D. J.; Konermann, L. Ultrarapid Desalting of Protein Solutions for Electrospray Mass Spectrometry in a Microchannel Laminar Flow Device. Anal. Chem. 2005, 77 (21), 6887-6894. https://doi.org/10.1021/ac0509020.
Dasgupta, P. K.; Bligh, R. Q.; Mercurio, M. A. DUAL MEMBRANE ANNULAR HELICAL SUPPRESSORS IN ION CHROMATOGRAPHY. Anal. Chem. 1985, 57 (2), 484-489. https://doi.org/10.1021/ac50001a038.
Dasgupta, P. K. ANNULAR HELICAL SUPPRESSOR FOR ION CHROMATOGRAPHY. Anal. Chem. 1984, 56 (1), 103-105. https://doi.org/10.1021/ac00265a028.
Strong, D. L.; Dasgupta, P. K. Electrodialytic Membrane Suppressor for Ion Chromatography. Anal. Chem. 1989, 61 (9), 939-945. https://doi.org/10.1021/ac00184a005.
Chen, Y.; Mori, M.; Pastusek, A. C.; Schug, K. A.; Dasgupta, P. K. On-Line Electrodialytic Salt Removal in Electrospray Ionization Mass Spectrometry of Proteins. Anal. Chem. 2011, 83 (3), 1015-1021. https://doi.org/10.1021/ac102809c.
Bazinet, L.; Moalic, M. Coupling of Porous Filtration and Ion-Exchange Membranes in an Electrodialysis Stack and Impact on Cation Selectivity: A Novel Approach for Sea Water Demineralization and the Production of Physiological Water. Desalination 2011, 277 (1-3), 356-363. https://doi.org/10.1016/j.desal.2011.04.058.
Galier, S.; Balmann, H. R. De. The Electrophoretic Membrane Contactor: A Mass-Transfer-Based Methodology Applied to the Separation of Whey Proteins. Sep. Purif. Technol. 2011, 77 (2), 237-244. https://doi.org/10.1016/j.seppur.2010.12.013.
Galier, S.; Roux-de Balmann, H. Study of the Mass Transfer Phenomena Involved in an Electrophoretic Membrane Contactor. J. Memb. Sci. 2001, 194 (1), 117-133. https://doi.org/10.1016/S0376-7388 (01) 00527-0.
Aider, M.; Brunet, S.; Bazinet, L. Electroseparation of Chitosan Oligomers by Electrodialysis with Ultrafiltration Membrane (EDUF) and Impact on Electrodialytic Parameters. J. Memb. Sci. 2008, 309 (1-2), 222-232. https://doi.org/10.1016/j.memsci.2007.10.029.
Suwal, S.; Roblet, C.; Doyen, A.; Amiot, J.; Beaulieu, L.; Legault, J.; Bazinet, L. Electrodialytic Separation of Peptides from Snow Crab By-Product Hydrolysate: Effect of Cell Configuration on Peptide Selectivity and Local Electric Field. Sep. Purif. Technol. 2014, 127, 29-38. https://doi.org/10.1016/j.seppur.2014.02.018.
Ohira, S. I.; Kuhara, K.; Kudo, M.; Kodama, Y.; Dasgupta, P. K.; Toda, K. Electrodialytic Ion Isolation for Matrix Removal. Anal. Chem. 2012, 84 (12), 5421-5426. https://doi.org/10.1021/ac300982k.
Ohira, S. I.; Kuhara, K.; Shigetomi, A.; Yamasaki, T.; Kodama, Y.; Dasgupta, P. K.; Toda, K. On-Line Electrodialytic Matrix Isolation for Chromatographic Determination of Organic Acids in Wine. J. Chromatogr. A 2014, 1372, 18-24. https://doi.org/10.1016/j.chroma.2014.10.077.
Ohira, S. I.; Hiroyama, Y.; Nakamura, K.; Koda, T.; Dasgupta, P. K.; Toda, K. Electrodialytic Matrix Isolation for Metal Cations. Talanta 2015, 132, 228-233. https://doi.org/10.1016/j.talanta.2014.09.013.
Nakamura, Y.; Maeda, S.; Nishiyama, H.; Ohira, S. I.; Dasgupta, P. K.; Toda, K. Micro Ion Extractor for Single Drop Whole Blood Analysis. Anal. Chem. 2015, 87 (13), 6483-6486. https://doi.org/10.1021/acs.analchem.5b01681.
Ohira, S. I.; Nakamura, K.; Shelor, C. P.; Dasgupta, P. K.; Toda, K. Simultaneous Electrodialytic Preconcentration and Speciation of Chromium (III) and Chromium (VI). Anal. Chem. 2015, 87 (22), 11575-11580. https://doi.org/10.1021/acs.analchem.5b03464.
Ohira, S. I.; Yamasaki, T.; Koda, T.; Kodama, Y.; Toda, K. Electrodialytic In-Line Preconcentration for Ionic Solute Analysis. Talanta 2018, 180, 176-181. https://doi.org/10.1016/j.talanta.2017.12.054.
Mori, M.; Sagara, K.; Arai, K.; Nakatani, N.; Ohira, S. I.; Toda, K.; Itabashi, H.; Kozaki, D.; Sugo, Y.; Watanabe, S.; Ishioka, N. S.; Tanaka, K. Simultaneous Analysis of Silicon and Boron Dissolved in Water by Combination of Electrodialytic Salt Removal and Ion-Exclusion Chromatography with Corona Charged Aerosol Detection. J. Chromatogr. A 2016, 1431, 131-137. https://doi.org/10.1016/j.chroma.2015.12.064.
Kachuk, C.; Faulkner, M.; Liu, F.; Doucette, A. A. Automated SDS Depletion for Mass Spectrometry of Intact Membrane Proteins Though Transmembrane Electrophoresis. J. Proteome Res. 2016, 15 (8), 2634-2642. https://doi.org/10.1021/acs.jproteome.6b00199.
Haddad, P. R.; Jackson, P. E.; Shaw, M. J. Developments in Suppressor Technology for Inorganic Ion Analysis by Ion Chromatography Using Conductivity Detection. Journal of Chromatography A. Elsevier Jun. 6, 2003, pp 725-742. https://doi.org/10.1016/S0021-9673 (02) 01999-4.
Yang, B.; Chen, Y.; Mori, M.; Ohira, S. I.; Azad, A. K.; Dasgupta, P. K.; Srinivasan, K. Charge Detector for the Measurement of Ionic Solutes. Anal. Chem. 2010, 82 (3), 951-958. https://doi.org/10.1021/ac9021902.
Alvarado, L.; Chen, A. Electrodeionization: Principles, Strategies and Applications. Electrochim. Acta 2014, 132, 583-597. https://doi.org/10.1016/j.electacta.2014.03.165.
Rbeida, O.; Christiaens, B.; Hubert, P.; Lubda, D.; Boos, K. S.; Crommen, J.; Chiap, P. Evaluation of a Novel Anion-Exchange Restricted-Access Sorbent for on-Line Sample Clean-up Prior to the Determination of Acidic Compounds in Plasma by Liquid Chromatography. In Journal of Chromatography A; Elsevier, 2004; Vol. 1030, pp 95-102. https://doi.org/10.1016/j.chroma.2003.11.031.
Chiap, P.; Rbeida, O.; Christiaens, B.; Hubert, P.; Lubda, D.; Boos, K. S.; Crommen, J. Use of a Novel Cation-Exchange Restricted-Access Material for Automated Sample Clean-up Prior to the Determination of Basic Drugs in Plasma by Liquid Chromatography. J. Chromatogr. A 2002, 975 (1), 145-155. https://doi.org/10.1016/S0021-9673 (02) 01334-1.
Kielland, J. Individual Activity Coefficients of Ions in Aqueous Solutions. J. Am. Chem. Soc. 1937, 59 (9), 1675-1678. https://doi.org/10.1021/ja01288a032.
Righetti, P. G.; Caravaggio, T. Isoelectric Points and Molecular Weights of Proteins. A Table. Journal of Chromatography A. Elsevier Apr. 21, 1976, pp 1-28. https://doi.org/10.1016/S0021-9673 (00) 98537-6.
Caldwell, K. D.; Kesner, L. F.; Myers, M. N.; Giddings, J. C. Electrical Field-Flow Fractionation of Proteins. Science (80-.). 1972, 176 (4032), 296-298. https://doi.org/10.1126/science.176.4032.296.
Kesner, L. F.; Caldwell, K. D.; Myers, M. N.; Giddings, J. C. Performance Characteristics of Electrical Field-Flow Fractionation in a Flexible Membrane Channel. Anal. Chem. 1976, 48 (13), 1834-1839. https://doi.org/10.1021/ac50007a007.

### Additional Embodiments

Some additional, non-limiting, example embodiments are provided below.

Embodiment 1. A membrane system or device comprising:
a first size selective membrane;
a first ion exchange membrane; and
an effluent channel in fluidic communication with the first size selective membrane.

Embodiment 2. The system or device of Embodiment 1, wherein:
the first ion exchange membrane is in contact with the first size selective membrane; and the first size selective membrane is positioned between the effluent channel and the first ion exchange membrane.

Embodiment 3. The system or device of Embodiment 1 or Embodiment 2, further comprising:
a second size selective membrane in fluidic communication with the effluent channel;
and
a second ion exchange membrane,
wherein the second size selective membrane is positioned between the effluent channel and the second ion exchange membrane, and
wherein the second size selective membrane is positioned on an opposite side of the effluent channel from the first size selective membrane.

Embodiment 4. The system or device of Embodiment 3, wherein the first ion exchange membrane and the second ion exchange membrane are independently a cation exchange membrane or an anion exchange membrane, such as wherein the second ion exchange membrane is a cation exchange membrane or an anion exchange membrane, and wherein the first ion exchange membrane is the same or different from the second ion exchange membrane.

Embodiment 5. The system or device of any of the preceding Embodiments, wherein the first size selective membrane comprises an ultrafiltration membrane or a dialysis membrane.

Embodiment 6. The system or device of Embodiment 5, wherein the ultrafiltration membrane has a molecular weight cut off (MWCO) of from 0.1-1000 kDa or a MWCO of no greater than 15 kDa.

Embodiment 7. The system or device of Embodiment 6, wherein the molecular weight cut off is no less than 0.5 kDa and no greater than 10 kDa.

Embodiment 8. The system or device of any of the preceding Embodiments, further comprising a first pair of electrodes positioned on opposite sides of the effluent channel.

Embodiment 9. The system or device of Embodiment 8, wherein the first pair of electrodes comprises an anode and a cathode.

Embodiment 10. The system or device of Embodiment 8, further comprising n additional pairs of electrodes positioned on opposite sides of the effluent channel, wherein n is no less than 1 and no greater than 1000.

Embodiment 11. The system or device of Embodiment 10, wherein the n additional pairs of electrodes are adjacent to one another and spaced along the effluent channel.

Embodiment 12. The system or device of any of Embodiments 3-11, further comprising:
an anolyte channel in fluidic communication with the first ion-exchange membrane;
an anolyte inlet for providing an anolyte to the anolyte channel;
a catholyte channel in fluidic communication with the second ion-exchange membrane;
and
a catholyte inlet for providing a catholyte to the catholyte channel.

Embodiment 13. A method of desalting comprising:
providing a membrane system or device according to any of Embodiments 1-12, such as a device comprising a first size selective membrane, a first ion exchange membrane, and an effluent channel in fluidic communication with the first size selective membrane; and introducing a fluid stream to the effluent channel of the membrane device; and moving the fluid stream through the effluent channel of the device.

Embodiment 14. The method of Embodiment 13, further comprising:
obtaining a desalted stream from the effluent channel of the device.

Embodiment 15. The method of Embodiment 14, wherein the fluid stream comprises:
a protein; and
a denaturant, such as a denaturant comprising a guanidinium ion.

Embodiment 16. An analysis system comprising:
a liquid chromatograph;
a mass spectrometer; and
a membrane system or device according to any of Embodiments 1-12, wherein the device is positioned in fluidic communication between the liquid chromatograph and the mass spectrometer.

Embodiment 17. A method of fluid analysis comprising:
providing an analysis system according to Embodiment 16;
introducing a fluid stream to a separation column of the liquid chromatograph;
moving the fluid stream through the separation column to provide an eluted fluid stream;
providing the eluted fluid stream to the effluent channel of the membrane device;
moving the fluid stream through the effluent channel to provide a desalted fluid stream;
introducing the desalted fluid stream to an inlet of the mass spectrometer; and
analyzing the desalted fluid stream using the mass spectrometer.

Embodiment 18. The method of Embodiment 17, wherein the separation column is an ion exchange column, reverse phase column, hydrophilic interaction column, size exclusion column, or a hydrophobic interaction column.

Embodiment 19. The method of Embodiment 18, wherein the fluid stream has a flow rate of no less than 0.1 mL/min and no greater than 10 mL/min or the fluid stream has a flow rate from about 0.001 mL/min to about 10 mL/min.

Embodiment 20. The method of any of Embodiments 17-19, wherein a residence time of the membrane device is less than 30 seconds.

Embodiment 21. The method of Embodiment 20, wherein the residence time is less than 10 seconds and greater than 0.5 seconds.

Embodiment 22. The method of Embodiment 17, wherein the fluid stream comprises a biomolecule.

Embodiment 23. The method of Embodiment 22, wherein the fluid stream comprises a protein, an oligonucleotide, or both.

Embodiment 24. The method of Embodiment 22, wherein:
the eluted fluid stream comprises the biomolecule and has a first conductivity; or the eluted fluid stream comprises the biomolecule and one or more salts at a first salt concentration.

Embodiment 25. The method of Embodiment 24, wherein:
the desalted fluid stream comprises the biomolecule and has a second conductivity, wherein the second conductivity is lower than the first conductivity; or the desalted fluid stream comprises the biomolecule and is free of the one or more salts or comprises the one or more salts at a second salt concentration, wherein the second salt concentration is lower than the first salt concentration.

Embodiment 26. The method of Embodiment 25, wherein:
the second conductivity is at least 90% lower than the first conductivity; or the second salt concentration is at least 90% lower than the first salt concentration.

Embodiment 27. The method of Embodiment 17, wherein:
the membrane device further comprises a first pair of electrodes positioned on opposite sides of the effluent channel; and
the method further comprises applying a first voltage to the first pair of electrodes.

Embodiment 28. The method of Embodiment 27, wherein:
the membrane device further comprises n additional pairs of electrodes positioned on opposite sides of the effluent channel, wherein n is no less than 1 and no greater than 1000; and
the method further comprises applying n additional voltages to the n additional pairs of electrodes.

Embodiment 29. The method of Embodiment 28, wherein the first voltage has the same magnitude as one or more of the n additional voltages.

Embodiment 30. The method of Embodiment 28, wherein the first voltage has a different magnitude than one or more of the n additional voltages.

Embodiment 31. The method of Embodiment 28, wherein the first voltage and/or one or more of the n additional voltages are static.

Embodiment 32. The method of Embodiment 28, wherein the first voltage and/or one or more of the n additional voltages are dynamic.

Embodiment 33. The method of Embodiment 28, wherein the first voltage and/or one or more of the n additional voltages are provided by a constant current source.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and sub-combinations are of utility and can be employed without reference to other features and sub-combinations and are contemplated within the scope of the claims.

1. A membrane system comprising:
a first size selective membrane;
a first ion exchange membrane, the first ion exchange membrane being in contact with the first size selective membrane;
a second size selective membrane;
a second ion exchange membrane; and
an effluent channel in fluidic communication with the first size selective membrane and the second size selective membrane;
wherein the first size selective membrane is positioned between the effluent channel and the first ion exchange membrane, and the second size selective membrane is positioned between the effluent channel and the second ion exchange membrane, and
wherein the second size selective membrane is positioned on an opposite side of the effluent channel from the first size selective membrane.

2. The system of claim 1, wherein the first ion exchange membrane and the second ion exchange membrane are independently a cation exchange membrane or an anion exchange membrane.

3. The system of claim 1, wherein the second ion exchange membrane is a cation exchange membrane or an anion exchange membrane, and wherein the first ion exchange membrane is the same or different from the second ion exchange membrane.

4. The system of claim 1, wherein the first size selective membrane comprises an ultrafiltration membrane or a dialysis membrane.

5. The system of claim 4, wherein the ultrafiltration membrane has a molecular weight cut off (MWCO) of no greater than 15 kDa.

6. The system of claim 5, wherein the MWCO is no less than 0.5 kDa and no greater than 10 kDa.

7. The system of claim 1, further comprising a first pair of electrodes positioned on opposite sides of the effluent channel.

8. The system of claim 7, wherein the first pair of electrodes comprises an anode and a cathode.

9. The system of claim 7, further comprising n additional pairs of electrodes positioned on opposite sides of the effluent channel, wherein n is no less than 1 and no greater than 1000.

10. The system of claim 9, wherein the n additional pairs of electrodes are adjacent to one another and spaced along the effluent channel.

11. The system of claim 1, further comprising:
an anolyte channel in fluidic communication with the first ion exchange membrane;
an anolyte inlet for providing an anolyte to the anolyte channel;
a catholyte channel in fluidic communication with the second ion exchange membrane; and
a catholyte inlet for providing a catholyte to the catholyte channel.

12. A method of desalting comprising:
providing a membrane system according to claim 1;
introducing a fluid stream to the effluent channel of the membrane system; and
moving the fluid stream through the effluent channel of the membrane system.

13. The method of claim 12, further comprising:
obtaining a desalted stream from the effluent channel of the membrane system.

14. The method of claim 12, wherein the fluid stream comprises at least one of a protein and a denaturant.

15. The method of claim 14, wherein the denaturant comprises a guanidinium ion.

16. An analysis system comprising:
a liquid chromatograph;
a mass spectrometer; and
a membrane system according to claim 1, wherein the membrane system is positioned in fluidic communication between the liquid chromatograph and the mass spectrometer.

17-33. (canceled)
